(19) United States
(12) Patent Application Publication
(10) Pub. No.: US 2026/0311077 A1
(43) Pub. Date: Oct. 8, 2026

(54) APPARATUS AND COMPUTER-IMPLEMENTED METHOD FOR DYNAMIC MODELING OF EVENTS INCLUDING A GRAPHICAL USER INTERFACE

(71) Applicant: Travis James Arlitt, Houston, TX (US)

(72) Inventor: Travis James Arlitt, Houston, TX (US)

(21) Appl. No.: 19/169,275

(22) Filed: Apr. 3, 2025

(51) Int. Cl. G06Q 10/0631

(52) U.S. Cl. CPC G06Q 10/06311

(57) ABSTRACT

A computer-implemented method and apparatus of dynamic modeling of events including a graphical user interface are disclosed. The method includes loading, into one or more computer memory devices, a digitized representation of a plurality of predecessor events, wherein the plurality of predecessor events comprises one or more event attributes, computing a first execution profile of each of a plurality of successor events as a function of, at least in part, the one or more event attributes, generating, using the at least a processor, a first visual representation, generating a dynamic user interface including the first visual representation, receiving a user input through the dynamic user interface, computing a second execution profile as a function of the user input, generating a second visual representation and generating the dynamic user interface comprising the second visual representation.

### FIELD OF THE INVENTION

The present invention generally relates to the field of computer-implemented systems, devices, and/or computing platforms. In particular, the present invention is directed to an apparatus and computer-implemented method for dynamic modeling of events.

### BACKGROUND

Traditionally, event modeling and progress prediction rely on static methodologies. Conventional event modeling techniques often fail to dynamically generate and update events based on changes in data, real-time variations, or dynamic constraints. Additionally, user interfaces in this field typically lack the capability to provide real-time updates, dynamic redistribution of data, or interactive modification of data attributes. Accordingly, there is a need for an improved system and method for dynamic modeling of events including an improved graphical user interface.

### SUMMARY OF THE DISCLOSURE

In an aspect, a computer-implemented method of dynamic modeling of events including a graphical user interface is described. The method includes loading, using at least a processor into one or more computer memory devices, a digitized representation of a plurality of predecessor events, wherein the plurality of predecessor events includes one or more event attributes, computing, using the at least a processor, a first execution profile of each of a plurality of successor events as a function of, at least in part, the one or more event attributes, wherein computing the first execution profile includes identifying at least a profile parameter of the plurality of predecessor events, wherein the at least a profile parameter includes one or more of a ramp-up phase and a ramp-down phase and generating the first execution profile as a function of the at least a profile parameter, generating, using the at least a processor, a first visual representation including one or more first visual data points, wherein each of the one or more first visual data points represents each of the plurality of predecessor events and the first execution profile of each of the plurality of successor events, generating, using the at least a processor, a dynamic user interface including the first visual representation, receiving, using the at least a processor, a user input through the dynamic user interface, computing, using the at least a processor, a second execution profile as a function of the user input, wherein computing the second execution profile includes modifying at least a part of the one or more event attributes of the plurality of predecessor events as a function of the user input, generating, using the at least a processor, a second visual representation including one or more second visual data points as a function of the second execution profile and generating, using the at least a processor, the dynamic user interface including the second visual representation.

In another aspect, an apparatus for modeling a multi-event process including a graphical user interface is described. The apparatus includes at least one processor and one or more computer memory devices communicatively connected to the at least one processor, wherein the one or more computer memory devices contains instructions configuring the at least one processor to load, into the one or more computer memory devices, a digitized representation of a plurality of predecessor events, wherein the plurality of predecessor events includes one or more event attributes, compute a first execution profile of each of a plurality of successor events as a function of, at least in part, the one or more event attributes, wherein computing the first execution profile includes identifying at least a profile parameter of the plurality of predecessor events, wherein the at least a profile parameter includes one or more of a ramp-up phase and a ramp-down phase and generating the first execution profile as a function of the at least a profile parameter, generate a first visual representation including one or more first visual data points, wherein each of the one or more first visual data points represents each of the plurality of predecessor events and the first execution profile of each of the plurality of successor events, generate a dynamic user interface including the first visual representation, receive a user input through the dynamic user interface, compute a second execution profile as a function of the user input, wherein computing the second execution profile includes modifying at least a part of the one or more event attributes of the plurality of predecessor events as a function of the user input, generate a second visual representation including one or more second visual data points as a function of the second execution profile and generate the dynamic user interface including the second visual representation.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an exemplary apparatus for dynamic modeling of events including a graphical user interface;

FIG. 2A illustrates an exemplary embodiment of a graph showing job processes in a schedule of a multi-event process to be performed at various points in time;

FIG. 2B illustrates an exemplary embodiment of a graph showing a execution profile of process events over a period of weeks;

FIG. 3 illustrates an exemplary embodiment of a graph showing a execution profile of process events and a resultant bow wave in response to a shortcoming in weekly progress, according to an embodiment;

FIG. 4 illustrates an exemplary embodiment of a graph showing respreading of process events in response to delayed completion of a predecessor event;

FIG. 5 illustrates an exemplary embodiment of a graph showing respread process events, indicating increasing and decreasing rates of progress, in response to delayed completion of a predecessor event;

FIG. 6 illustrates a flowchart for an exemplary method for computer-implemented modeling of a multi-event process;

FIG. 7 illustrates a schematic block diagram illustrating an exemplary computing system environment;

FIG. 8 illustrates a schematic block diagram illustrating an exemplary computing environment to facilitate computer-implemented modeling of a multi-event process;

FIG. 9 illustrates a first exemplary embodiment of a graph showing respreading of process events in response to linking of a computer-implemented model for a multi-event process with a computer-implemented calendaring tool;

FIG. 10 illustrates a second exemplary embodiment of a graph showing respreading of process events in response to linking of a computer-implemented model for a multi-event process with a computer-implemented calendaring tool;

FIG. 11 illustrates a third exemplary embodiment of a graph showing respreading of process events in response to linking of a computer-implemented model for a multi-event process with a computer-implemented calendaring tool;

FIG. 12A illustrates a visual representation of planned hourly events related to a process of driving from a point “A” to a point “C”;

FIG. 12B illustrates a revised visual representation of planned hourly events responsive to a speculation based, at least in part, on an alternative driving scenario;

FIG. 12C illustrates a visual representation of respread hourly events related to a process of driving from point “A” to point “C” responsive to another alternative driving scenario;

FIG. 12D illustrates a visual representation of planned hourly events related to a process of driving from a point “A” to a point “C”;

FIG. 12E illustrates a visual representation showing speculated hourly events related to driving from point “A” to point “C” in view of predecessor events being below originally planned progress;

FIG. 12F illustrates a visual representation showing actual predecessor and speculated future events related to driving from point “A” to point “C” in view of predecessor events being below originally planned progress;

FIGS. 13A-B illustrate exemplary dynamic user interfaces;

FIGS. 14A-B illustrate exemplary first visual representation and second visual representation;

FIG. 15 illustrates exemplary digitized representations of predecessor events and corresponding exemplary visual representations;

FIG. 16 illustrates a block diagram of an exemplary machine-learning module;

FIG. 17 illustrates a diagram of an exemplary neural network;

FIG. 18 illustrates a block diagram of an exemplary node in a neural network;

FIG. 19 illustrates a flow diagram of an exemplary method for dynamic modeling of events including a graphical user interface; and

FIG. 20 illustrates a block diagram of a computing system that can be used to implement any one or more of the methodologies disclosed herein and any one or more portions thereof.

### DETAILED DESCRIPTION

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same embodiment or to any one particular embodiment described. Furthermore, it is to be understood that particular features, structures, representations, indications and/or characteristics described are capable of being combined in various ways in one or more embodiments and, therefore, are within intended claim scope, for example. In general, of course, these and other issues vary with context. Therefore, particular context of description and/or usage provides guidance regarding inferences to be drawn.

In a multi-event process, which may involve various time-phased processes, subprocesses, and/or events, a contractor, for example, may submit a proposal, which may include a time-phased process schedule to indicate the various processes, subprocesses, and/or events to be executed during a period of performance. Thus, a proposed schedule may indicate certain activities, many of which are scheduled to be performed prior to initiation of certain other activities. For example, a contractor proposing to construct a freeway bypass, bridge, or other structure, may begin with surveying, excavation, and grading prior to preparation of rebar substructures and form setting, which may be followed by pouring concrete, masonry, and other processes. In many instances, detailed scheduling of construction activities may be subject to oversight by a contracting officer, who may be tasked with ensuring that a contractor performs all needed activities, preferably in accordance with the proposed schedule and a proposed budget.

However, in some instances, a contractor, for example, may experience difficulties in adhering to an agreed-upon schedule of a multi-event construction process. In such instances, the contractor, for example, may wish to revise and/or update the agreed-upon schedule so as to reschedule certain activities. Such replanning of construction activities may be based, at least in part, on delays due to weather, availability of materials, equipment, availability of appropriate tradespeople, unplanned and/or unscheduled work stoppages, holidays, workplace mishaps, and so forth.

Consequently, a contractor may prepare a revised schedule, which, hopefully, provides the contracting officer or other overseer, for example, with a revised time-phased process schedule that indicates the contractor's plan for minimizing delays, cost overruns, and so forth. Such re-scheduling of the various time-phased processes may influence the contracting officer's scheduling of progress payments made to the contractor as well as allocating certain resources that the contractor may need to complete the multi-event process. In many instances, however, such contractor-provided schedule updates may be suspected, obscured, or not readily available so as to provide little insight into the contractor's actual plan of the multi-event process. Accordingly, improvements in multi-event scheduling continue to be an active area of investigation.

As described herein, a “multi-event process” is a various time-phase process having one or more subprocesses, events, and the like. In some cases, a contractor, for example, may submit a proposal, which may include a time-phased schedule of process events. A time-phased process schedule, which may indicate process events to occur on a daily basis, weekly basis, monthly basis, etc., may be utilized to indicate the various processes, subprocesses, and/or events to be executed during a contractor's period of performance. Thus, a proposed schedule for completing a multi-event process may indicate certain time-phased activities, many of which may be scheduled to be performed prior to initiation of certain other activities. In an example, a contractor proposing to construct a freeway bypass, bridge, chemical processing facility, refinery, or any other structure or system of structures, may begin with surveying, excavation, and/or grading prior to preparation of rebar substructures and form setting, piping, etc., which may be followed by pouring concrete, masonry, application of asphalt, and other processes. In many instances, detailed scheduling of construction activities may be subject to oversight by a contracting officer, who may be tasked with ensuring that the one or more contractors perform all needed activities, preferably in accordance with the proposed schedule and within a proposed budget.

However, in some instances, a contractor, may experience difficulties in adhering to an agreed-upon schedule of a multi-event construction process. In such instances, the contractor, for example, may wish to revise and/or update the agreed-upon schedule so as to reschedule certain activities. Rescheduling and/or replanning of construction activities may place a premium on completing the multi-event process at a particular, and previously agreed-upon, completion date. In some instances, replanning and/or rescheduling of construction activities may be in response to construction delays due to unforeseen weather interruptions, a contractor performance factor, availability of materials, equipment constraints, availability of skilled tradespeople, unplanned and/or unscheduled work stoppages, holidays, workplace mishaps, and so forth.

In such embodiment, while executing a multi-event-process, a contractor may prepare a revised schedule or other type of plan for the completion of the multi-event process, which, hopefully, provides the contracting officer, customer, or other type of overseer, with a revised time-phased process schedule that specifies, in appropriate detail, the contractor's plan or approach for minimizing delays, cost overruns, and so forth. Such re-scheduling of the various time-phased processes may influence the contracting officer's scheduling of progress payment intervals to be made to the contractor as well as allocating certain resources that the contractor may need to complete the multi-event process. In many instances, however, such contractor-provided schedule updates may be suspected, obscured, or not available in a timely manner. Accordingly, in some instances, contractor-provided schedule updates may provide little insight into the contractor's actual plan for completion of the multi-event process.

In a non-limiting example, a contractor may utilize a typical scheduling tool that does not provide sufficient granularity in identifying events of various processes and/or subprocesses of a multi-event process. Thus, in such instances, a contractor may provide a contracting officer, customer, or other overseer, with a revised schedule that includes only a handful (e.g., 7, 10, or 15, or more or less) of replanned process events, which may not embody sufficient detail to appropriately advise the contracting officer, customer, or other overseer. Further, typical scheduling tools may operate in an unwieldy manner, which may not permit the contractor to provide timely updates to the contracting officer or other overseer. Such typical scheduling tools may thus permit a contractor to hide or obscure replanned/rescheduled details of a multi-event process. Such hiding or obscuration of replanned details of a multi-event process may place the contracting officer, customer, or other type of overseer into a state of relative ignorance as to which processes, subprocesses, and/or events of the multi-event process are being delayed and/or impacted.

Accordingly, in some embodiments, apparatus as described herein i.e., a computer-implemented modeling tool for a multi-event process or dynamic modeling of events including a graphical user interface may overcome a number of shortcomings present in typical scheduling tools. In a non-limiting example, apparatus described herein may be configured to provide one or more visual representations, such as a bar graph, Gantt chart, or other indication, that quickly and interactively displays respread events of a process in response to modifying an event attribute of one or more predecessor events. As described herein, an “event attribute” refers to a parameter relating to at least one event. In a non-limiting example, event attribute of an originally scheduled predecessor event may refer a date (e.g., timestamp) of completion of the predecessor event. Accordingly, as used in this disclosure, a “modified event attribute” is a modification of a parameter of a predecessor event. In some cases, a modified event attribute of a predecessor event may refer to a delay in completing one or more predecessor events, a shortening of a duration of one or more predecessor events, or modifying any other parameter of the predecessor event. Predecessor events may be used interchangeably with “historical events” as described herein.

Additionally, in some embodiments, apparatus as described herein may overcome a number of inefficiencies and shortcomings present in graphical user interface (GUI) design and/or layout. Apparatus and computer-implemented method disclosed herein may highlight an interactive nature of GUI that allows updating data and displaying it promptly in response to user input using an event handler. Unlike conventional systems that rely on static data representations and require manual recalculations, the disclosed GUI dynamically modifies visual representations based on user interactions. The GUI is interactive in several ways. The interactivity of the GUI allows users to manipulate graphical elements and a plurality of event handlers that detects various changes in the graphical elements and triggers generation or changes in event attributes, execution profiles and visual representations. In some embodiments, users may manipulate graphical elements, such as dragging or resizing timeline bars, adjusting start and end dates, or modifying production estimates, which directly trigger updates to underlying event attributes. Furthermore, the GUI provides an intuitive interface for comparing different progress scenarios.

In a non-limiting example, in response to modifying an event attribute of the predecessor event, such as realizing a delay in completion of one or more predecessor events of a series of time-phased events, apparatus as described herein may include a facility to permit a user such as a contractor to indicate that remaining events of the series of events are to be completed at a faster rate (e.g., a greater percentage of completion per day, per week, per month, etc.) so as to maintain an agreed-upon completion date. Thus, in one possible example, in response to a two-week weather or holiday delay, which affects the rate at which concrete can be poured, apparatus as described herein may be configured to indicate that the contractor is required to pour concrete at a faster rate during the remaining weeks allocated for concrete pouring events.

In some embodiments, apparatus as described herein may be utilized to quickly and interactively display one or more visual representations of respread events of a first process in response to, for example, a delay in completing one or more predecessor events of a second process. For example, in a possible embodiment, in response to a process comprising laying of underground pipes in a multi-event process of constructing an oil refinery, a two-week delay in fabricating and laying pipes into open trenches, such as due to holiday-related personnel shortages or any other event that affects a contractor performance factor, may delay a first process pipe weld inspection and/or covering of completed pipe trenches with earth. In such an instance, in view of the two-week delay in constructing and laying pipes, a contractor may be tasked with increasing a rate of pipe weld inspection and covering of completed pipe trenches during the remaining weeks allocated for covering piped-out trenches with earth or other materials.

In some embodiments, one or more predecessor events may be linked or coupled to a time-phased schedule of process events. As used in this disclosure, a “link” between a predecessor event of the time-phased schedule of process events is a relationship between the predecessor and subsequent process events, in which the predecessor event is to be completed prior to or coincident with initiation of the time-phased schedule of process events. In a non-limiting example, a predecessor inspection event that refers to inspection of pipe weld quality may be essential prior to covering a piped-out trench with earth. In another non-limiting example, a predecessor event may be “linked” to a plurality of time-phased process events. In a further non-limiting example, a predecessor event relating to assembly of a concrete-mixing facility, or completed up to a certain percentage, may be scheduled to occur prior to two or more time-phased process events, such as surveying, obtaining one or more concrete pumps, form setting, and so forth.

In addition, in some embodiments, apparatus described herein utilize a computing platform that facilitates interactive real-time or near-real-time viewing of various contingency scenarios. Thus, based, at least in part, on computing power of a computing platform, such as via the use of multiple processors, enhanced memory caching, and/or other computer hardware features, a contracting officer or other overseer may be capable of interactively generating visual representations of revised scheduling details with merely a few computer keystrokes. Thus, it may be appreciated that computer-implemented modeling of a multi-event process may provide the ability to interactively generate numerous informal or “what if” speculations based on virtually any number of scenarios, for example, in completing scheduled events of a multi-event process.

It may be appreciated that, at least in particular embodiments, an ability to quickly and/or interactively replan and/or reschedule events of a multi-event process, may be instrumental in assisting a contractor, for example, in avoiding certain scenarios in which a delay of one or more process events gives rise to an undesirable “bow wave” of activity at a future date of a scheduled process. In this context, the term “bow wave” refers to an undesirable accumulation of effects of an estimation process in which one or more delays in a sequential series of events leads to a burst of activity at a future date. In one possible example, if a series of process events involves pouring concrete at a completion rate of 5% per week for 20 weeks, a shortcoming in weekly concrete pouring events, such as pouring concrete at a rate of 4% per week for 19 weeks, leads to a need to pour a remaining 24% of concrete at week 20. Thus, it may be appreciated that precluding such “bow wave” events from occurring may serve the interests of contractors as well as contracting officers and/or customers alike.

In some embodiments, at least one processor may facilitate the interactive generation of one or more visual representations showing increasing rates of progress (e.g., “ramp up”) over time as well as decreasing rates (e.g., “ramp down”) of progress. Thus, in one possible example, as rainy weather decreases during spring and summer months, process events may be interactively scheduled and visually represented to show increases, such as from a execution profile of 3% per week in March to a execution profile of 6% per week in June, followed by, for example, a execution profile that returns to 3% during rain-prone November.

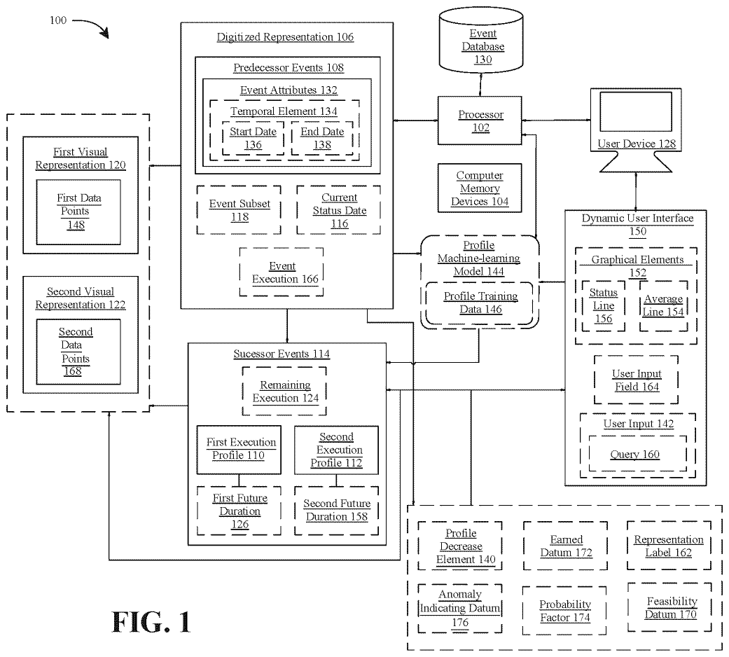

Referring now to FIG. 1, a block diagram of an exemplary apparatus 100 for dynamic modeling of events including a graphical user interface is illustrated. Apparatus 100 includes at least a processor 102. Processor 102 may include, without limitation, any processor described in this disclosure. Processor 102 may be included in a computing device. Processor 102 may include any computing device as described in this disclosure, including without limitation a microcontroller, microprocessor, digital signal processor (DSP) and/or system on a chip (SoC) as described in this disclosure. Processor 102 may include, be included in, and/or communicate with a mobile device such as a mobile telephone or smartphone. Processor 102 may include a single computing device operating independently, or may include two or more computing device operating in concert, in parallel, sequentially or the like; two or more computing devices may be included together in a single computing device or in two or more computing devices. Processor 102 may interface or communicate with one or more additional devices as described below in further detail via a network interface device. Network interface device may be utilized for connecting processor 102 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 102 may include but is not limited to, for example, a computing device or cluster of computing devices in a first location and a second computing device or cluster of computing devices in a second location. Processor 102 may include one or more computing devices dedicated to data storage, security, distribution of traffic for load balancing, and the like. Processor 102 may distribute one or more computing tasks as described below across a plurality of computing devices of computing device, which may operate in parallel, in series, redundantly, or in any other manner used for distribution of tasks or memory between computing devices. Processor 102 may be implemented, as a non-limiting example, using a “shared nothing” architecture.

With continued reference to FIG. 1, processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 102 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes one or more computer memory devices 104 communicatively connected to processor 102. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, computer memory device 104 contains instructions configuring processor 102 to load a digitized representation 106 of a plurality of predecessor events 108 into one or more computer memory devices 104. For the purposes of this disclosure, a “digitized representation” refers to a form or structure of data that is in a machine-readable format. As a non-limiting example, digitized representation 106 may include encoded signals, computational models, or other electronically stored information. In some embodiments, digitized representation 106 may be generated through signal processing, data encoding, or computational transformation techniques. As a non-limiting example, digitized representation 106 may be generated through analog-to-digital conversion, event logging, cryptographic hashing, feature extraction, machine-learning-based transformation, or the like. In some embodiments, digitized representation 106 of predecessor events 108 and predecessor events 108 described with respect to FIG. 1 may be consistent with any digitized representation of predecessor events and predecessor events described with respect to FIGS. 1-19.

With continued reference to FIG. 1, for the purposes of this disclosure, a “predecessor event” is an occurrence that was instantiated prior to a current status date. In some embodiments, predecessor event 108 may serve as a trigger, an initiating condition, or a contributing factor influencing subsequent processes, computations, or state changes. As a non-limiting example, processor 102 may compute first execution profile 110, second execution profile 112, successor events 114, and the like as a function of predecessor event 108 as described further in detail below. The second execution profile 112 is further described below. In some embodiments, predecessor event 108 may represent an aggregated outcome over a defined time period. In a non-limiting example, predecessor events 108 may be daily basis, weekly basis, monthly basis, quarterly bases, and the like. As a non-limiting example, predecessor event 108 may include total production, operational metrics, or project milestones recorded for past time intervals. As a non-limiting example, predecessor event 108 may include an actual production output for a given month, with a first predecessor event 108 representing a total production that occurred during a first month prior to a current status date 116, a second predecessor event 108 representing an actual production during a second month before the current status date 116, and so forth.

With continued reference to FIG. 1, for the purposes of this disclosure, a “current status date” is a reference timestamp corresponding to a moment when a user accesses an apparatus 100. As a non-limiting example, current status date 116 may be a moment when a user triggers retrieval, processing, or display of most up-to-date information related to predecessor events 108. In a non-limiting example, a current status date 116 may represent a present day when production figures are examined by a user. In some embodiments, current status date 116 described with respect to FIG. 1 may be consistent with any status date described with respect to FIGS. 1-19.

With continued reference to FIG. 1, in some embodiments, predecessor event 108 may be associated with a production or project management. As a non-limiting example, digitized representation 106 of predecessor event 108 may include information related to a production of oil and gas. In some embodiments, digitized representation 106 of predecessor event 108 may include information related to a benchmark of productions or projects. In some embodiments, predecessor event 108 may include operational milestones. As a non-limiting example, predecessor event 108 may include a completion of a manufacturing process, an outcome of a project phase, a measurement of productivity metrics within a given timeframe, or the like. In some embodiments, predecessor event 108 include a quantified productivity level, representing efficiency, output, performance within a specified operational context, or the like. As a non-limiting example, predecessor event 108 may include data related to monthly production of a given product. For instance, and without limitation, predecessor event 108 may include records of oil and gas production measured on a monthly basis until a current status date 116. As another non-limiting example, predecessor event 108 may include comparative production data. For example, and without limitation, predecessor event 108 may include actual monthly output compared against estimated or planned production targets (e.g., target attribute) represented in percentages. In a non-limiting example, digitized representation 106 of each of a plurality of predecessor events 108 may indicate that a company earned $108,750 on Feb. 22, 2026, $206,083 on Mar. 1, 2026, $221,491 on Mar. 7, 2026, and the like. In another non-limiting example, digitized representation 106 of predecessor event 108 may indicate the number of hours utilized or expended each month for a given production process or project. In another non-limiting example, digitized representation 106 of predecessor event 108 may reflect a quantity of manufactured or produced goods within a defined time period before a current status date 116.

With continued reference to FIG. 1, in some embodiments, each of a plurality of predecessor events 108 may be an aggregation of a plurality of event subsets 118. In some embodiments, digitized representation 106 of predecessor events 108 may include information related to event subsets 118. For the purposes of this disclosure, an “event subset” is a contributing element that reflects a specific component, or subset of a predecessor event. In some embodiments, event set 118 may include an individual factor or unit of measurement that contributes to a characterization or quantification of predecessor event 108. As a non-limiting example, event subset 118 may include factory units of a project or production, departments or functional areas of a project or production, specific tasks of a project, and the like. For example, and without limitation, for gas and oil production, event subset 118 may include structural, mechanical, piping, electrical, instrumentation, fireproofing, insulating, painting departments or functional areas, and the like. For example, and without limitation, for gas and oil production, event subset 118 may include a plurality of units of structural, mechanical, piping, electrical, instrumentation, fireproofing, insulating, painting departments or functional areas, and the like. In some embodiments, processor 102 may generate first visual representation 120 and/or second visual representation 122 as a function of event subsets 118. In some embodiments, processor 102 may generate first execution profile 110 and/or second execution profile 112 as a function of event subsets 118. In some embodiments, generation of first visual representation 120, second visual representation 122, first execution profile 110 and/or second execution profile 112 for event subsets 118 may be consistent with generation of first visual representation 120, second visual representation 122, first execution profile 110 and/or second execution profile 112 for predecessor events and successor events 114 as described in detail below. As a non-limiting example, processor 102 may generate first visual representation 120 as a function of event subset 118 by spreading remaining execution 124 of event subset 118 over to a first future duration 126 of successor events 114. In some embodiments, event subset described with respect to FIG. 1 may be consistent with any subset described with respect to FIGS. 1-19.

With continued reference to FIG. 1, in some embodiments, processor 102 may receive digitized representation 106 of a plurality of predecessor events 108 from a user device 128. For the purposes of this disclosure, a “user device” is any device a user uses to input data. As a non-limiting example, user device 128 may include a laptop, desktop, tablet, mobile phone, smart phone, smart watch, kiosk, screen, smart headset, or things of the like. In some embodiments, user device 128 may include an interface configured to receive inputs from user as described below. In some embodiments, user may manually input any data into apparatus 100 using user device 128. In some embodiments, user may have a capability to process, store or transmit any information independently. For the purposes of this disclosure, a “user” is any person or individual that is using or has used an apparatus. As a non-limiting example, a user may include a project manager, engineer, and the like.

With continued reference to FIG. 1, in some embodiments, processor 102 may receive digitized representation 106 of a plurality of predecessor events 108 from an event database 130. In some embodiments, apparatus 100 may include an event database 130. As used in this disclosure, “event database” is a data structure configured to store data associated with events. In one or more embodiments, event database 130 may include inputted or calculated information and datum related to events (e.g., predecessor event 108, successor event 114, and the like). In some embodiments, a datum history may be stored in event database 130. As a non-limiting example, the datum history may include real-time and/or previous inputted data related to events. As a non-limiting example, event database 130 may include instructions from a user, who may be an expert user, a past user in embodiments disclosed herein, or the like, where the instructions may include examples of the data related to events.

With continued reference to FIG. 1, in some embodiments, processor 102 may be communicatively connected with event database 130. For example, and without limitation, in some cases, event database 130 may be local to processor 102. In another example, and without limitation, event database 130 may be remote to processor 102 and communicative with processor 102 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 102 connect directly, dynamically, and non-hierarchically to as many other computing devices as possible. A “network topology” as used in this disclosure is an arrangement of elements of a communication network. The network may use an immutable sequential listing to securely store event database 130. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, event database 130 may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, processor 102 may receive digitized representation 106 of a plurality of predecessor events 108 from application programming interface (API). As used in the current disclosure, an “application programming interface” is a software interface for two or more computer programs to communicate with each other. An application programming interface may be a type of software interface, offering a service to other pieces of software. In contrast to a user interface, which connects a computer to a person, an application programming interface may connect computers or pieces of software to each other. An API may not be intended to be used directly by a person (user) other than a computer programmer who is incorporating it into the software. An API may be made up of different parts which act as tools or services that are available to the programmer. A program or a programmer that uses one of these parts is said to call that portion of the API. The calls that make up the API are also known as subroutines, methods, requests, or endpoints. An API specification may define these calls, meaning that it explains how to use or implement them. One purpose of API may be to hide the internal details of how a system works, exposing only those parts a programmer will find useful and keeping them consistent even if the internal details later change. An API may be custom-built for a particular pair of systems, or it may be a shared standard allowing interoperability among many systems. The term API may be often used to refer to web APIs, which allow communication between computers that are joined by the internet. API may be configured to query for web applications in order to retrieve digitized representation 106 of predecessor events 108 to another web application, data database, internal firm database, company portal, and the like. An API may be further configured to filter through web applications according to a filter criterion. In this disclosure, “filter criteria” are conditions the web applications must fulfill in order to qualify for API. Web applications may be filtered based on these filter criteria. Filter criteria may include, without limitation, types of productions or projects, scopes of productions or projects, and the like.

With continued reference to FIG. 1, a plurality of predecessor events 108 includes one or more event attributes 132. In some embodiments, event attribute 132 may provide descriptive, quantitative, or qualitative information about events (e.g., predecessor event 108, successor event 114, and the like). As a non-limiting example, event attribute 132 may include magnitude, duration, source, status, and/or the like. As another non-limiting example, event attribute 132 may include information related to required materials, employees, specialists, operating cost, and/or the like. As another non-limiting example, event attribute 132 may include information related to resource allocation, a level or value of production, used time for a project, and/or the like. As another non-limiting example, event attribute 132 may include project information associated with predecessor events 108. For example, and without limitation, event attribute 132 may include a target attribute. For the purposes of this disclosure, a “target attribute” is a parameter relating to at least one event that defines a desired or expected characteristic, condition, or outcome associated with the event. As a non-limiting example, a target attribute may include a specified production output for a given time period, a predefined project completion percentage, a resource allocation threshold, or a financial objective such as an estimated earned value. In some embodiments, a target attribute may be compared against actual event attributes 132 to determine deviations as described below. For example, and without limitation, event attribute 132 may include a goal, target revenue, expected timeline, plan, and the like. In some embodiments, event attribute 132 may include may be used to analyze, classify, or process the event within a computing system. As a non-limiting example, an event attribute 132 may include a timestamp indicating when an event occurred, location identifier, categorical label, numerical value representing a measured parameter, or the like. In some embodiments, event attribute 132 may be stored in event database 130 and processor 102 may retrieve event attribute 132 from event database 130. In some embodiments, a user may manually input event attribute 132. In some embodiments event attribute 132 described with respect to FIG. 1 may be consistent with any event attributes described with respect to FIGS. 1-19.

With continued reference to FIG. 1, in some embodiments, digitized representation 106 of predecessor event 108 may include at least a temporal element 134. In some embodiments, event attributes 132 may include at least a temporal element 134. For the purposes of this disclosure, a “temporal element” is a data element that indicates time. As a non-limiting example, temporal element 134 may include a start date 136 and an end date 138 associated with any process related to predecessor event 108. For instance, and without limitation, temporal element 134 may indicate a date on which the production commenced and a projected or scheduled completion date. For instance, and without limitation, temporal element 134 may indicate a date on which the production commenced and a date on which the production finished. In some embodiments, each of event subset 118 may include temporal elements 134. For the purposes of this disclosure, a “start date” is an initiating point in time at which a specific process, project milestone, or production cycle starts. As a non-limiting example, start date 136 may include a project initiation date, a date when predecessor events 108 started, and the like. For the purposes of this disclosure, an “end date” is a final point in time at which a specific process, project milestone, or production cycle concludes. As a non-limiting example, end date 138 may include a project completion date, a date when successor events 114 are expected to complete, or the like. In some embodiments, temporal element 134 may be further described with respect to FIGS. 1-19.

With continued reference to FIG. 1, computer memory device 104 contains instructions configuring processor 102 to compute a first execution profile 110 of a plurality of successor events 114 as a function of, at least in part, one or more event attributes 132. For the purposes of this disclosure, a “first execution profile” is a predicted progress of predecessor events based on an temporal element. As a non-limiting example, first execution profile 110 may include predicted production level, predicted project completion level, anticipated working hour, and the like during successor events 114. For example, and without limitation, first execution profile 110 may include production figures or contractor counts required for each month to achieve a finish date (temporal element 134). In a non-limiting example, first execution profile 110 may include production figures required to meet a target completion date (temporal element 134). In a non-limiting example, first execution profile 110 may include an estimated number of contractors necessary to achieve project milestones within a specified timeframe (temporal element 134). In some embodiments, first execution profile 110 may be stored in event database 130 and processor 102 may retrieve first execution profile 110 from event database 130. In some embodiments, user may manually input first execution profile 110. In some embodiments, first execution profile 110 described with respect to FIG. 1 may be consistent with any execution profiles described with respect to FIGS. 1-19.

With continued reference to FIG. 1, for the purposes of this disclosure, a “successor event” is an occurrence that is predicted to be instantiated after a current status date 116. In some embodiments, processor 102 may generate successor events 114 based on digitized representation 106 of predecessor events 108 and/or event attributes 132 (e.g., temporal element 134, event subset 118, and the like). In a non-limiting example, successor event 114 may include predicted levels (first execution profile 110) of oil and gas production for upcoming months (temporal elements 134) based on prior performance trends and planned capacity expansions (digitized representation 106 of predecessor events 108). In some embodiments, successor event 114 may represent an aggregated outcome over a defined time period. In a non-limiting example, successor event 114 may be daily basis, weekly basis, monthly basis, quarterly bases, and the like. As a non-limiting example, successor event 114 may include overall production, operational metrics, or project milestones projected for future time intervals (temporal element 134). As a non-limiting example, successor event 114 may correspond to a total production output expected for a given month. For example, and without limitation, successor events 114 may include a first successor event 114 representing a projected production for a first month after a current status date 116, a second successor event 114 representing a projected production for a second month, and so forth. In some embodiments, successor events 114 described with respect to FIG. 1 may be consistent with any successor events or future events described with respect to FIGS. 1-19.

With continued reference to FIG. 1, in some embodiments, each of a plurality of successor events 114 may be derived from an aggregation of a plurality of event subsets 118. In some embodiments, first execution profile 110 of successor events 114 may include information related to event subsets 118. In some embodiments, event subset 118 may include an individual factor or unit of measurement that contributes to first execution profile 110 of successor event 114. As a non-limiting example, each of event subset 118 may include production volumes for individual factory units, productivity levels of different operational departments, or the like. For example, and without limitation, in the context of oil and gas production, a first successor event 114 may represent predicted total oil extraction for a first month, with event subsets 118 including projected output contributions from different drilling sites, production units, and operational teams and a second successor event 114 may represent projected oil extraction for a second month, with the same event subsets 118.

With continued reference to FIG. 1, in some embodiments, processor 102 may generate first execution profile 110 as a function of a profile parameter, an average value, a maximum value, and the like. Computing first execution profile 110 includes identifying at least a profile parameter of plurality of predecessor events 108 and generating the first execution profile 110 as a function of the at least a profile parameter. For the purposes of this disclosure, a “profile parameter” is a characteristic or pattern in a predecessor events. In some embodiments, at least a profile parameter may include one or more of a ramp-up phase and a ramp-down phase. For the purposes of this disclosure, a “ramp-up phase” is a phase within a plurality of predecessor events that indicates an increasing rate of progress. As a non-limiting example, ramp-up phase may include a phase within a timeframe of predecessor events 108 where a production level is increased (ramped-up) from 20,000 to 50,000. For the purposes of this disclosure, a “ramp-down phase” is a phase within a plurality of predecessor events that indicates a decreasing rate of progress. As a non-limiting example, ramp-down phase may include a phase within a timeframe of predecessor events 108 where a production level is decreased (ramped-down) from 50,000 to 20,000. In some embodiments, processor 102 may detect profile parameter (e.g., ramp-up phase and/or ramp-down phase) from historical predecessor events and/or historical successor events. In some embodiments, historical predecessor events and/or historical successor events may be retrieved from event database 130.

With continued reference to FIG. 1, in some embodiments, profile parameter may include a profile decrease element 140. As a non-limiting example, predecessor events 108 may include a ramp-down phase and/or ramp-up phase due to a presence of profile decrease element 140 within the timeframe of the predecessor events 108. For example, and without limitation, severe winter storm may cause a ramp-down phase within the timeframe of predecessor events 108. In a non-limiting example, based on ramp-up phase and/or ramp-down phase of predecessor events, processor 102 may predict a first execution profile 110 to include similar ramp-up phase and/or ramp-down phrase throughout a future duration. For example, and without limitation, if predecessor events have ramp-down phase during Thanksgiving holidays week, processor 102 may compute first execution profile 110 to include similar ramp-down phase and spread out remaining execution throughout successor events 114 accordingly.

With continued reference to FIG. 1, in some embodiments, processor 102 may calculate an average of production, productivity, expenses, and the like (event attributes 132) of predecessor events 108 and compute first execution profile 110 as a function of the calculation. For example, and without limitation, if an average of production of a product is 500,000, processor 102 may make a prediction (first execution profile 110) of how much it'd take to achieve a targeted production value if the average production rate is equivalent to 500,000. For example, and without limitation, if an average of production of a product is 500,000, processor 102 may make a prediction (first execution profile 110) of a maximum production rate required to achieve a targeted production value.

With continued reference to FIG. 1, in some embodiments, processor 102 may generate first execution profile 110 as a function of a profile decrease element 140. For the purposes of this disclosure, a “profile decrease element” is a parameter that influences a reduction or slowdown of a first execution profile over time. In some embodiments, profile decrease element 140 may reflect external conditions, operational constraints, systemic inefficiencies, or the like that result in lower-than-expected production levels, delays in project completion, decreased efficiency in resource utilization, or the like associated with first execution profile 110. In some embodiments, profile decrease element 140 may represent one or more conditions or variables that may negatively impact or reduce first execution profile 110 of successor events 114. In a non-limiting example, by incorporating the profile decrease element 140 into the computation of the first execution profile 110, processor 102 may generate more accurate predictions that account for real-world constraints and deviations from ideal production or project timelines. As a non-limiting example, profile decrease element 140 may include external influences. For example, and without limitation, profile decrease element 140 may include adverse weather conditions that disrupt production schedules, national or regional holidays that reduce workforce availability, unforeseen operational disruptions, equipment malfunctions or supply chain delays, or the like. In another non-limiting example, profile decrease element 140 may account for seasonal variations in production output, regulatory restrictions that temporarily limit operational capacity, workforce availability fluctuations that affect projected productivity levels, or the like. In some embodiments, profile decrease element 140 may include a degree of profile decrease element 140. As a non-limiting example, profile decrease element 140 may include a level of intensity of profile decrease element 140. For example, and without limitation, profile decrease element 140 may include a severe hurricane (e.g., 100% hurricane risk) and a mild hurricane risk (e.g., 50% hurricane risk). In some embodiments, processor 102 may adjust or generate first execution profile 110 as a function of profile decrease element 140. For instance, and without limitation, if weather forecasts indicate a severe storm in a production region, processor 102 may reduce the predicted production levels (first execution profile 110) of each of plurality of successor events 114 for an affected time period. For instance, and without limitation, if a national holiday is approaching, processor 102 may decrease an estimated working hours (first execution profile 110) in a corresponding successor event 114 to reflect reduced labor availability. In some embodiments, profile decrease element 140 may be stored in event database 130 and processor 102 may retrieve profile decrease element 140 from event database 130. In some embodiments, user may manually input profile decrease element 140. In a non-limiting example, user input 142 may include profile decrease element 140. In some embodiments, processor 102 may determine first execution profile 110 of successor events 114 as a function of an average of predecessor events 108. In a non-limiting example, an average of production level of predecessor events 108 may be used to generate an average of predicted production level (first execution profile 110) of successor events 114.

With continued reference to FIG. 1, in some embodiments, processor 102 may generate first execution profile 110 using a profile machine-learning model 144. In some embodiments, processor 102 may be configured to generate profile training data 146. In a non-limiting example, profile training data 146 may include correlations between exemplary digitized representations of predecessor events, exemplary event attributes, exemplary user inputs and/or exemplary execution profiles. In some embodiments, profile training data 146 may be stored in event database 130. In some embodiments, profile training data 146 may be received from one or more users, event database 130, external computing devices, and/or previous iterations of processing. As a non-limiting example, profile training data 146 may include instructions from a user, who may be an expert user, a past user in embodiments disclosed herein, or the like, which may be stored in memory and/or stored in event database 130, where the instructions may include labeling of training examples. In some embodiments, profile training data 146 may be updated iteratively on a feedback loop. As a non-limiting example, processor 102 may update profile training data 146 iteratively through a feedback loop as a function of digitized representation 106 of predecessor events 108, first execution profile 110, second execution profile 112, user inputs 142, event attributes 132, event subsets 118, or the like. In some embodiments, processor 102 may be configured to generate a profile machine-learning model 144. In a non-limiting example, generating profile machine-learning model 144 may include training, retraining, or fine-tuning profile machine-learning model 144 using profile training data 146 or updated profile training data 146. In some embodiments, processor 102 may be configured to determine first execution profile 110 using profile machine-learning model 144 (i.e. trained or updated profile machine-learning model 144). In some embodiments, generating training data and training machine-learning models may be simultaneous.

With continued reference to FIG. 1, computer memory device 104 contains instructions configuring processor 102 to generate a first visual representation 120. For the purposes of this disclosure, a “first visual representation” is a depiction of predecessor events and successor events in a visual format based on a digitized representation of predecessor events and a first execution profile of successor events. As a non-limiting example, first visual representation 120 may include a graph, chart, diagram, schematic, and the like. For example, and without limitation, first visual representation 120 may include a time-series graph displaying production trends over successive months. For example, and without limitation, first visual representation 120 of predecessor events 108 and successor events 114 may include a Gantt chart. For example, and without limitation, first visual representation 120 may include a bar chart comparing actual production figures (predecessor events 108) against projected targets (successor events 114). For example, and without limitation, first visual representation 120 may include a workflow diagram illustrating relationships between different operational phases. In some embodiments, processor 102 may generate first visual representation 120 of a plurality of event subsets 118 of predecessor events 108 and successor events 114. In some embodiments, first visual representation 120 may be stored in event database 130 and processor 102 may retrieve first visual representation 120 from event database 130. In some embodiments, user May manually input first visual representation 120. In some embodiments, first visual representation 120 described with respect to FIG. 1 may be consistent with any visual representations described with respect to FIGS. 1-19.

With continued reference to FIG. 1, first visual representation 120 includes one or more first visual data points 148. For the purposes of this disclosure, a “first visual data point” is a graphical element that represents individual predecessor events and corresponding first execution profiles of successor events within a visual representation. As a non-limiting example, first visual data point 148 may include a bar in a bar chart. As another non-limiting example, first visual data point 148 may include a labeled marker within a timeline visualization (first visual representation 120), a color-coded region in a heatmap (first visual representation 120), a highlighted section of a gauge chart (first visual representation 120), and the like. As another non-limiting example, first visual data point 148 may include icons, arrows, lines, or shading variations within first visual representation 120. Each of one or more first visual data points 148 represents each of a plurality of predecessor events 108 and first execution profile 110 of each of a plurality of successor events 114. As a non-limiting example, in a bar chart (first visual representation 120) containing a plurality of bars (first visual data points 148), each bar may serve as a first visual data point 148 corresponding to a specific time period. For example, and without limitation, a first bar may represent an actual production level of a first predecessor event, a second bar may represent an actual production level of a second predecessor event, a third bar may represent a predicted production level of a first successor event 114, and so forth. In some embodiments, first visual representation 120 may include a plurality of first visual data points 148. In some embodiments, first visual representation 120 may include at least one first visual data point 148 positioned over another at least one first visual data point 148. In some embodiments, first visual data point 148 may be stored in event database 130 and processor 102 may retrieve first visual data point 148 from event database 130. In some embodiments, user may manually input first visual data point 148. In some embodiments, first visual data point 148 described with respect to FIG. 1 may be consistent with any first visual data points described with respect to FIGS. 1-19.

With continued reference to FIG. 1, computer memory device 104 contains instructions configuring processor 102 to generate a dynamic user interface 150 including first visual representation 120. For the purposes of this disclosure, a “dynamic user interface” is a user interface that adapts in real-time to user interactions, or changes in data. In some embodiments, dynamic user interface 150 may be designed to provide a personalized and responsive experience by updating its content, layout, or functionality based on user input 142, first execution profile 110, second execution profile 112, temporal element 134, event attribute 132, or the like. In some embodiments, dynamic user interface 150 may include first visual representation 120, first visual data points 148, digitized representation 106 of predecessor events 108, event attributes 132, temporal element 134, first execution profile 110, successor events 114, event subset 118, user input 142, second execution profile 112, second visual representation 122, and the like. The user input 142 and second visual representation 122 disclosed herein are further described below. In some embodiments, processor 102 may generate a prompt related to first visual representation 120 and/or second visual representation 122 for a user, display the prompt to the user and update or modify first visual representation 120 and/or second visual representation 122 based on a user input 142 for the prompt. As a non-limiting example, processor 102 may generate a prompt asking a user if the user wants to modify any elements displayed within first visual representation 120 and/or second visual representation 122. In some embodiments, processor 102 may automatically update first visual representation 120 and/or second visual representation 122.

With continued reference to FIG. 1, for the purposes of this disclosure, a “user interface” is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof and the like. In some embodiments, user interface may operate on and/or be communicatively connected to a decentralized platform, metaverse, and/or a decentralized exchange platform associated with the user. For example, a user may interact with user interface in virtual reality. In some embodiments, a user may interact with the use interface using a computing device distinct from and communicatively connected to at least a processor 102. For example, a smart phone, smart, tablet, or laptop operated by a user. In an embodiment, user interface may include a graphical user interface. A “graphical user interface,” as used herein, is a graphical form of user interface that allows users to interact with electronic devices. In some embodiments, GUI may include icons, menus, other first visual data points or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, in some embodiments, processor 102 may generate dynamic user interface 150 including an event handler. An “event handler” as used in this disclosure is a callback routine that operates asynchronously once an event takes place. Event handlers may include, without limitation, one or more programs to perform one or more actions based on user input, such as generating pop-up windows, submitting forms, changing background colors of a webpage, and the like. Event handlers may be programmed for specific user input 142, such as, but not limited to, mouse clicks, mouse hovering, touchscreen input, keystrokes, and the like. For instance and without limitation, an event handler may be programmed to generate a pop-up window if a user double clicks on a specific icon. In some embodiments, dynamic user interface 150 may include an event handler associated with a status line 156 of graphical elements 152 of the dynamic user interface 150. In some embodiments, event handler may be configured to detect a change in a position of the status line 156 (user input 142) and trigger a change in at least a part of second visual representation 122 as a function of the detection. In some embodiments, the dynamic user interface 150 may include an event handler associated with a profile decrease element 140. In some embodiments, event handler may be configured to detect a selection (user input 142) of the profile decrease element 140 and trigger a change in at least a part of second visual representation 122 as a function of the selected profile decrease element 140. In some embodiments, dynamic user interface 150 may include an event handler associated with any graphical elements 152.

With continued reference to FIG. 1, computer memory device 104 contains instructions configuring processor 102 to receive a user input 142 through dynamic user interface 150. For the purposes of this disclosure, a “user input” is any data inputted to a processor 102 by a user. As a non-limiting example, user input 142 may include typed text. In some embodiments, user input 142 may include gestures such as swiping or dragging to rearrange elements, voice commands, or file uploads. In some embodiments, user input 142 may include a manipulation of computer icons, such as, but not limited to, clicking, selecting, dragging and dropping, scrolling, and the like. In some embodiments, user input 142 may be associated with a manipulation of graphical elements 152 of dynamic user interface 150. In some embodiments, at least a part of graphical elements 152 may be associated with one or more first visual data points 148. As a non-limiting example, user input 142 may be associated with average line 154, status line 156, temporal element 134, estimated loss or gain, first visual representation 120, first visual data points 148, start date 136, end date 138, first future duration 126, second future duration 158, benchmark value, and/or the like. The average line 154, the benchmark value, and the status line 156 disclosed herein are further described in detail below. For example, and without limitation, user may manually input a benchmark value and processor 102 may generate second execution profile 112 so that future duration of successor events 114 and required productivity, working hours and/or production (second execution profile 112 of successor events 114) may be modified to achieve the benchmark value. For example, and without limitation, user input 142 may include a manipulation of each bar of a bar chart and processor 102 may update or generate second visual representation 122 as a function of the manipulation of the bar. For the purposes of this disclosure, a “graphical element” is a visual component within a user interface. As a non-limiting example, graphical elements 152 may include charts, graphs, icons, buttons, progress bars, animations, or the like.

With continued reference to FIG. 1, in some embodiments, graphical element 152 may represent an average of predecessor events 108 and/or successor events 114. For example, and without limitation, graphical element 152 may include lines (e.g., average line 154) indicating an average of production level of predecessor events 108 and average of predicted production level (first execution profile 110) of successor events 114 placed over a bar chart (first visual representation 120) and/or bars (visual data points) in the bar chart. For the purposes of this disclosure, an “average line” is a graphical element that indicates an average of a execution profile. In some embodiments, generating first and/or second execution profile may show how a user or project team doing an average work or specific amount of work would it impact the future work or progress. In some embodiments, processor 102 may compute an average value of predecessor events 108 and/or successor events 114 based on digitized representation 106 of predecessor events 108, first execution profile 110, second execution profile 112, metadata of successor events 114, and/or the like.

With continued reference to FIG. 1, in some embodiments, graphical element 152 may represent a benchmark for first execution profile 110 and/or second execution profile 112. In some embodiments, graphical element 152 may include a benchmark line. For the purposes of this disclosure, a “benchmark line” is a graphical element that indicates a benchmark value for a first execution profile or second execution profile. As a non-limiting example, benchmark line may indicate an ideal or required value of productivity, production, and the like from executing successor events 114. As a non-limiting example, benchmark line may indicate a maximum planned hours, maximum earned hours, maximum required hours, maximum production, maximum productivity, or the like associated with predecessor events 108 and/or successor events 114. In some embodiments, processor 102 may compute a benchmark value of predecessor events 108 and/or successor events 114 based on digitized representation 106 of predecessor events 108, first execution profile 110, second execution profile 112, metadata of successor events 114, and/or the like.

With continued reference to FIG. 1, in some embodiments, graphical elements 152 may represent an expected or predicted value of productivity, production, and the like that can be made based on predecessor events 108 and successor events 114. In some embodiments, graphical element 152 may include a prediction line.

With continued reference to FIG. 1, in some embodiments, graphical element 152 may represent a current status date 116. In some embodiments, user input 142 may be associated with a manipulation of a status line 156 of graphical elements 152. As a non-limiting example, manipulation of status line 156 may include moving the status line 156 towards a first future duration 126. For the purposes of this disclosure, a “status line” is a graphical element that represents a current status date. In some embodiments, user may adjust an average of predecessor events 108 and/or successor events 114. In some embodiments, user input 142 may be associated with a profile decrease element 140. As a non-limiting example, user input 142 may include a type, degree, or the like of profile decrease element 140. In some embodiments, user input 142 may include a query 160. For the purposes of this disclosure, a “query” is a request for information. As a non-limiting example, query 160 may include a request for specific information related to predecessor events 108, successor events 114, execution profiles, visual representations, and the like. As a non-limiting example, query 160 may indicate which future duration a user wants to look at. In a non-limiting example, user input 142 may include a selection between a list of future durations associated with execution profiles and successor events 114. For example, and without limitation, dynamic user interface 150 may display graphical elements 152 representing different future durations (e.g., D10, D50, D90, or similar indicators, where D10 corresponds to a future duration of 10 days, D50 to 50 days, and D90 to 90 days). In some embodiments, query 160 may include a representation label 162 as described in this disclosure. In some embodiments, user input 142 may indicate a specific level of productivity or execution profile a user wants to look at. In a non-limiting example, user input 142 or query 160 may include a selection between a list of execution profiles. For example, and without limitation, dynamic user interface 150 may display graphical elements 152 representing different execution profiles (e.g., P10, P50, P90, or similar indicators, where P10 corresponds to a level of productivity of 10%, P50 to 50%, and P90 to 90%). A user may select one of these productivities, prompting processor 102 to display a visual representation reflecting the selected productivity. In some embodiments, as current status date 116 is modified based on a change of status line 156 by a user (user input 142), average line 154 of second visual representation 122, predecessor events 108 and/or second execution profile 112 of successor events 114 may be modified as well. In a non-limiting example, as a user extends or modifies a current status date 116 closer to an end of successor events 114, processor 102 may compute a second execution profile 112 based on a benchmark value (e.g., from benchmark line) or average value (e.g., from average line 154) of predecessor events.

With continued reference to FIG. 1, in some embodiments, user input 142 may include a plurality of profile parameters. As a non-limiting example, profile parameters may include an increasing rate and/or decreasing rate. For example, and without limitation, profile parameters may include increasing rates of progress over time (e.g., “ramp up”) as well as decreasing rates of progress (e.g., “ramp down”). In some embodiments, processor 102 may generate first execution profile 110 and/or second execution profile 112 as a function of profile parameter. For example, and without limitation, higher an increasing rate or decreasing rate is, steeper a graph (visual representation) may be generated.

With continued reference to FIG. 1, in some embodiments, user input 142 may include an entry of characters and/or symbols in a user input field 164. A “user input field” as used in this disclosure is a portion of a graphical user interface configured to receive data from an individual. A user input field 164 may include, but is not limited to, text boxes numerical fields, search fields, filtering fields, and the like. In some embodiments, user input 142 may include touch input. Touch input may include, but is not limited to, single taps, double taps, triple taps, long presses, swiping gestures, and the like. One of ordinary skill in the art will appreciate the various ways a user may interact with dynamic user interface 150.

With continued reference to FIG. 1, computer memory device 104 contains instructions configuring processor 102 to compute a second execution profile 112 as a function of user input 142. For the purposes of this disclosure, a “second execution profile” is a modified first execution profile based on a user input. In some embodiments, second execution profile 112 may be consistent with first execution profile 110. As a non-limiting example, second execution profile 112 may include predicted production level, predicted project completion level, anticipated working hour, and the like during successor events 114. For example, and without limitation, second execution profile 112 may include new production figures or contractor counts required to achieve a modified finish date (modified temporal element 134 as a function of user input 142). In a non-limiting example, second execution profile 112 may include updated production figures required to meet a target completion date (modified temporal element 134 as a function of user input 142). In a non-limiting example, second execution profile 112 may include an estimated number of contractors necessary to achieve project milestones within a modified timeframe (modified temporal element 134 as a function of user input 142). In some embodiments, second execution profile 112 may be stored in event database 130 and processor 102 may retrieve second execution profile 112 from event database 130. In some embodiments, user may manually input second execution profile 112. In some embodiments, processor 102 may generate second execution profile 112 using a profile machine-learning model 144 trained with profile training data 146. In a non-limiting example, profile training data 146 may include correlations between exemplary digitized representations of predecessor events, exemplary event attributes, exemplary temporal elements, exemplary user inputs and/or exemplary execution profiles. In some embodiments, processor 102 may compute second execution profile 112 as a function of profile decrease element 140. In some embodiments, second execution profile 112 described with respect to FIG. 1 may be consistent with any execution profiles described with respect to FIGS. 1-19.

With continued reference to FIG. 1, computing second execution profile 112 includes modifying at least a part of one or more event attributes 132 of a plurality of predecessor events 108 as a function of user input 142. In a non-limiting example, if user input 142 indicates that a user modified a project completion date or an end date 138 to be later or sooner, then processor 102 may modify temporal element 134 of event attributes 132 to reflect the updated timeline and may generate second execution profile 112 based on the modified project completion date. In some embodiments, processor 102 may update first execution profile 110 in response to user input 142 to generate second execution profile 112. In some embodiments, processor 102 may generate second execution profile 112 as a function of a benchmark value of event attributes 132. As a non-limiting example, benchmark value may include an amount of production, hours, productivity, and the like that must be earned to complete a project.

With continued reference to FIG. 1, in some embodiments, processor 102 may generate second execution profile 112 as a function of a change of current status date 116 (e.g., user input 142). In some embodiments, if the current status date 116 is extended further towards an end date 138, processor 102 may use an average rate or average value to generate second execution profile 112. In a non-limiting example, if a start date 136 is Jan. 1, 2025, end date 138 is Apr. 27, 2026, and the current status date is moved from May 15, 2025 to Oct. 15, 2025, processor 102 may generate execution profile for a period from the start date 136 to the modified current status date 116 based on an average rate or value of the period between Jan. 1, 2025 and May 15, 2025, and a execution profile for a period from the modified current status date 116 to the end date 138.

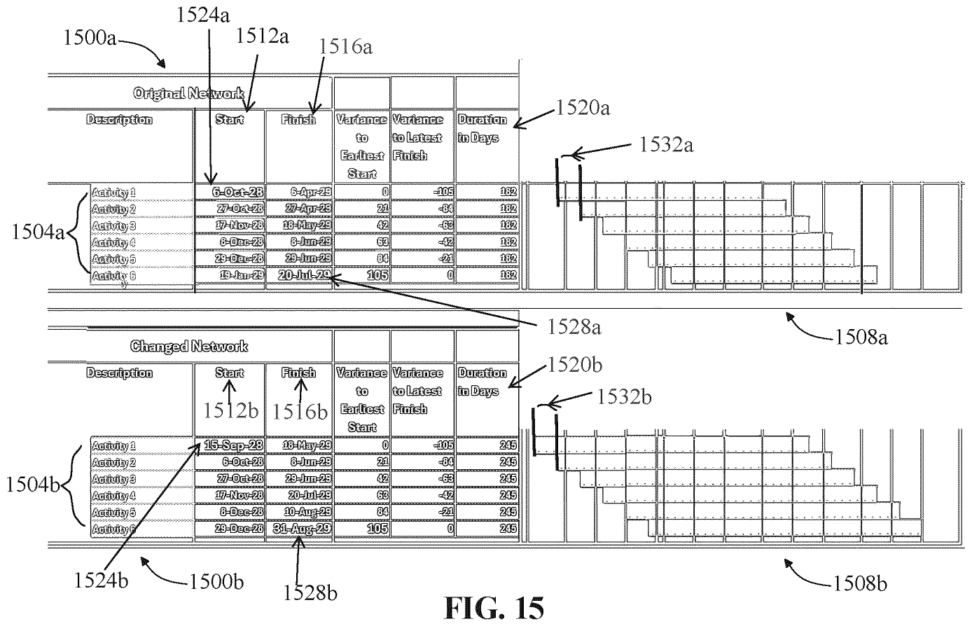

With continued reference to FIG. 1, in some embodiments, processor 102 may generate second execution profile 112 as a function of a duration gap between each of a plurality of predecessor events 108. For the purposes of this disclosure, a “duration gap” is a different between start dates and end dates of a predecessor event and a following predecessor event. For example, and without limitation, if start date 136 of a first predecessor event is Jan. 1, 2020, and start date 136 of a second predecessor event is Jan. 21, 2020, a duration gap between the start dates of two predecessor events is 20 days. For example, and without limitation, if end date 138 of a first predecessor event is Feb. 12, 2020, and end date 138 of a second predecessor event is Feb. 23, 2020, a duration gap between the end dates of two predecessor events is 11 days. As a non-limiting example, every start dates, end dates and durations of first execution profile 110 and first visual representation 120 may be modified based on a modified earliest start date and modified latest end date. For example, and without limitation, processor 102 may compute modified start dates, end dates and durations based on a duration gap between predecessor events 108. This ensures that while the modified start dates, end dates, and durations may be extended or shortened, duration gap between predecessor events remains unchanged. As a result, duration gap between predecessor events and duration gap between predecessor events may be maintained as identical. In a non-limiting example, if start date 136 of a first predecessor event is Jan. 1, 2020, start date 136 of a second predecessor event is Jan. 21, 2020, and start date 136 of a third predecessor event is Jan. 31, 2020 and when the earliest start date (e.g., start date 136 of the first predecessor event in this case) is modified to Dec. 29, 2020 (i.e., forwarded to start 3 days earlier), start dates 136 of the second predecessor event and the third predecessor event may be modified to Jan. 18, 2020 and Jan. 28, 2020 respectively. In some embodiments, duration gap may include days, times, numbers, amounts, and the like. In some embodiments, this can be used, by processor 102, to generate execution profiles and visual representations for multi-event process. The duration gap described herein may be further described in detail with respect to FIG. 15.

With continued reference to FIG. 1, in some embodiments, processor 102 may be configured to compute first execution profile 110 by spreading at least a portion of at least a percentage of a remaining execution 124 of each of the plurality of predecessor events 108 to over a first future duration 126 of a plurality of successor events 114 as a function of at least a percentage of an event execution 166 of each of plurality of predecessor events 108 and processor 102 may be configured to compute second execution profile 112 by respreading the at least a portion of the at least a percentage of the remaining execution 124 of each of the plurality of predecessor events 108 to over a second future duration 158 of the plurality of successor events 114 as a function of the at least a percentage of the event execution 166 of each of the plurality of predecessor events 108. For the purposes of this disclosure, an “event execution” is a measure of an advancement or completion level of a predecessor event based on an expected scope. As a non-limiting example, event execution 166 may be represented as a percentage, numerical value, or other measurable metric indicating how much of a predecessor event 108 has been completed relative to its total expected scope. For the purposes of this disclosure, a “remaining execution” is a portion of a predecessor event that has not been completed based on an expected scope. In some embodiments, remaining execution 124 may be determined by subtracting event execution 166 from a total expected completion of predecessor event 108. For example, and without limitation, a first percentage of first event execution associated with a first predecessor event 108 may be 60% and a second percentage of second event execution associated with a second predecessor event 108 may be 80%, indicating that 60% and 80% of the first and second predecessor events have been completed when it was expected to be completed 100%, while a first percentage of first remaining execution is 40% and a second percentage of second remaining execution is 20%, representing the unfinished portion of the first and second predecessor events. Continuing the non-limiting example, the first and second percentages of the first and second remaining executions, 40% and 20%, may be spread over first future duration 126 or second future duration 158 of execution profile (e.g., first execution profile 110 or second execution profile 112) of successor events 114.

With continued reference to FIG. 1, for the purposes of this disclosure, a “first future duration” is a duration between a current status date and an completion date of successor events based on a first execution profile. For the purposes of this disclosure, a “second future duration” is a duration between a current status date and an completion date of successor events based on a second execution profile. In some embodiments, processor 102 may determine second future duration 158 as a function of first future duration 126 and user input 142. For example, and without limitation, processor 102 may modify an end date 138 of first future duration 126 as a function of modification of the end date 138 (user input 142). In some embodiments, first future duration 126 and/or second future duration 158 may be associated with a current status date 116 and an end date 138 of temporal element 134. For example, and without limitation, if a current status date 116 is Jan. 1, 2026, and an end date 138 of temporal element 134 is Dec. 31, 2026, then first future duration 126 may span 12 months. In some embodiments, second future duration 158 may be consistent with first future duration 126. In some embodiments, first future duration 126 and/or second future duration 158 may be a period of time over which remaining execution 124 of a predecessor event 108 is expected to be distributed or spread across one or more successor events 114. In some embodiments, first future duration 126 and/or second future duration 158 may be determined based on predefined scheduling parameters, user input 142, or the like. For example, and without limitation, processor 102 may modify first future duration 126 when user input 142 indicates a change of a completion date (temporal element 134) of a project. In a non-limiting example, if a remaining execution 124 of a predecessor event 108 is 40% and the first future duration 126 consists of four months, processor 102 may distribute the remaining execution 124 equally over the four successor events 114, assigning 10% of the total predecessor event 108 to each month. In another non-limiting example, if the distribution may be weighted based on various factors (e.g., historical trends, resource availability, user input 142, profile decrease element 140, or the like), processor 102 may allocate different percentages of the remaining execution 124 to each successor event 114, dynamically adjusting the first execution profile 110 or second execution profile 112 accordingly. In some embodiments, user input 142 may include a manipulation of graphical element 152 to change an end date 138 of temporal element 134 and processor 102 may modify the temporal element 134 as a function of the user input 142, which may trigger a generation of second execution profile 112. For example, and without limitation, a user may interact with a graphical timeline or progress bar (graphical element 152) to extend or shorten an end date 138 of a project. If the user extends the end date 138, processor 102 may redistribute a remaining execution 124 across a longer future duration. Conversely, if the user shortens the end date 138, processor 102 may spread the remaining execution 124 into a shorter timeframe.

With continued reference to FIG. 1, in some embodiments, processor 102 may be configured to compute a first execution profile 110 by spreading at least a portion of a remaining execution 124 across a first future duration 126 associated with a plurality of successor events 114 as a function of a difference between an event execution 166 of a plurality of predecessor events 108 and a target attribute of one or more event attributes 132 and a proportion of each of the plurality of successor events 114 relative to a sum of the plurality of successor events 114. In some embodiments, processor 102 may be configured to compute a second execution profile 112 by respreading the at least a portion of the remaining execution 124 across a second future duration 158 associated with the plurality of successor events 114 as a function of the difference between the event execution 166 of a plurality of predecessor events 108 and the target attribute of the one or more event attributes 132 and a modified proportion of each of the plurality of successor events 114 relative to a modified sum of the plurality of successor events 114. Detailed description of these are described using an exemplary scenario below with Table 1.

With continued reference to FIG. 1, Table 1 (below) depicts a computer-implemented spreadsheet displaying predecessor events 108, successor events 114, and execution profiles. The table illustrates predecessor events 108 occurring on March 14th, 21st, and 28th, as well as successor events 114 occurring on April 4th, 11th, 18th, 25th, and May 2nd and 9th. Execution profiles (e.g., first execution profile 110, second execution profile 112, and the like) are represented as Profiles #1-4. Profiles #1 and 2 have a future duration from April 4^{th} to May 2^{nd}. Profile #2 shows a execution profile that indicates greater weather impact than Profile #1. Profile #3 have a future duration from April 4^{th} to May 9^{th}. Profile #4 have a future duration from April 4^{th} to May 9^{th} with a ramp-down phase. For predecessor events 108, event executions 166 (e.g., 9, 5, and 4 in Table 1) are shown as part of Executions #1-4. For successor events 114, remaining execution 124 is distributed across future durations of successor events 114 according to the respective execution profiles. Remaining execution 124 for each successor event 114 may be determined by calculating the deviation between the total value of event executions 166 and the targeted value, then distributing this remaining execution based on the proportional contribution of each successor event 114 (execution profiles) relative to the total execution across all successor events 114. The total remaining execution may be computed as follows:

$$Total Remaining Execution = Target Attribute - Total Event Execution of Predecessor Eve nts$$

The distribution of the computed total remaining execution to each successor event 114 may be determined by:

$$Distribution of Remaining Execution to Each of Successor Events = ( \frac{Execution Profile Value of a Successor Event}{Total Value of Execution Profiles of All Successor Events} ) \times Total Remaining Execution$$

For example, and without limitation, in the context of Table 1, if the targeted value (target attribute) is 200, the remaining execution 124 for April 4th (a successor event 114) in Profile #1 may be computed as follows:

$$\begin{matrix}200 - ( 9 + 5 + 4 ) = 182 ( Total Remaining Execution ) , \\ ( \frac{100}{460} ) \times 182 = 39.6 ( Distributed Remaining Execution for April 4 th ) .\end{matrix}$$

Notably, regardless of any modifications to successor events (e.g., future duration, end date 138, start date 136, profile decrease element 140, and the like) within Profiles #1-5, the total sum of event executions 166 and distributed remaining executions 124 remains unchanged, ensuring consistency in event modeling.

TABLE 1

| | Mar-14 | Mar-21 | Mar-28 | Apr-4 | Apr-11 | Apr-18 | Apr-25 | May-2 | May-9 | Total |
|---|---|---|---|---|---|---|---|---|---|---|
| Profile #1 | | | | 100% | 100% | 80% | 80% | 100% | | 460% |
| Execution #1 | 9 | 5 | 4 | 39.6 | 39.6 | 31.6 | 31.6 | 39.6 | | 200 |
| Profile #2 | | | | 100% | 100% | 50% | 50% | 100% | | 400% |
| Execution #2 | 9 | 5 | 4 | 45.5 | 45.5 | 22.75 | 22.75 | 45.5 | | 200 |
| Profile #3 | | | | 100% | 100% | 80% | 80% | 100% | 100% | 560% |
| Execution #3 | 9 | 5 | 4 | 32.5 | 32.5 | 26 | 26 | 32.5 | 32.5 | 200 |
| Profile #4 | | | | 100% | 100% | 80% | 80% | 50% | 25% | 435% |
| Execution #4 | 9 | 5 | 4 | 41.8 | 41.8 | 33.5 | 33.5 | 20.9 | 10.5 | 200 |

With continued reference to FIG. 1, computer memory device 104 contains instructions configuring processor 102 to generate a second visual representation 122 including one or more second visual data points 168 as a function of second execution profile 112. For the purposes of this disclosure, a “second visual representation” is a modified first visual representation based on a user input and a second execution profile. In some embodiments, second visual representation 122 may be consistent with first visual representation 120. As a non-limiting example, second visual representation 122 may include a graph, chart, diagram, schematic, and the like. For example, and without limitation, second visual representation 122 may include a time-series graph displaying production trends over successive months that was extended as a function of user input 142. For example, and without limitation, second visual representation 122 of predecessor events 108 and second execution profile 112 of successor events 114 may include a Gantt chart. For example, and without limitation, second visual representation 122 may include a bar chart comparing actual production figures (predecessor events 108) against modified projected targets (second execution profile 112). For example, and without limitation, second visual representation 122 may include a workflow diagram illustrating relationships between different operational phases. In some embodiments, processor 102 may generate second visual representation 122 of a plurality of event subsets 118 of predecessor events 108 and successor events 114. In some embodiments, second visual representation 122 may be stored in event database 130 and processor 102 may retrieve second visual representation 122 from event database 130. In some embodiments, user may manually input second visual representation 122. In some embodiments, processor 102 may generate a plurality of visual representations based on user input 142. As a non-limiting example, processor 102 may generate second visual representation 122, third visual representation, fourth visual representation, and/or the like. In some embodiments, second visual representation 122 described with respect to FIG. 1 may be consistent with any visual representations described with respect to FIGS. 1-19.

With continued reference to FIG. 1, second visual representation 122 includes one or more second visual data points 168. For the purposes of this disclosure, a “second visual data point” is a graphical element that represents individual predecessor events and corresponding second execution profiles of successor events within a visual representation. As a non-limiting example, second visual data point 168 may include a bar in a bar chart. As another non-limiting example, second visual data point 168 may include a labeled marker within a timeline visualization (second visual representation 122), a color-coded region in a heatmap (second visual representation 122), a highlighted section of a gauge chart (second visual representation 122), and the like. As another non-limiting example, second visual data point 168 may include icons, arrows, lines, or shading variations within second visual representation 122. Each of one or more second visual data points 168 may represent each of a plurality of predecessor events 108 and second execution profile 112 of each of a plurality of successor events 114. As a non-limiting example, in a bar chart (second visual representation 122) containing a plurality of bars (second visual data points 168), each bar may serve as a second visual data point 168 corresponding to a specific time period. For example, and without limitation, a second bar may represent an actual production level of a second predecessor event, a second bar may represent an actual production level of a second predecessor event, a third bar may represent a predicted production level of a second successor event 114, and so forth. In some embodiments, second visual representation 122 may include a plurality of second visual data points 168. In some embodiments, second visual representation 122 may include at least one second visual data point 168 positioned over another at least one second visual data point 168. In some embodiments, second visual data point 168 may represent a current status date 116. In some embodiments, second visual data point 168 may represent an average of predecessor events 108 and/or successor events 114. For example, and without limitation, second visual data point 168 may include lines (e.g., average line 154) indicating an average of production level of predecessor events 108 and average of predicted production level (second execution profile 112) of successor events 114 placed over a bar chart (second visual representation 122) and/or bars (second visual data point 168) in the bar chart. In some embodiments, second visual data point 168 may be stored in event database 130 and processor 102 may retrieve second visual data point 168 from event database 130. In some embodiments, user may manually input second visual data point 168. In some embodiments, second visual data point 168 described with respect to FIG. 1 may be consistent with any second visual data points described with respect to FIGS. 1-19.

With continued reference to FIG. 1, computer memory device 104 contains instructions configuring processor 102 to generate dynamic user interface 150 including second visual representation 122. In some embodiments, dynamic user interface 150 may present second visual representation 122 alongside or in comparison to first visual representation 120, allowing users to analyze differences between first execution profile 110 and/or first visual representation 120 and second execution profile 112 and/or second visual representation 122. As a non-limiting example, second visual data point 168 and/or second visual representation 122 may be positioned over or behind first visual data point 148 and/or first visual representation 120 to facilitate direct comparison. As another non-limiting example, second visual data point 168 and/or second visual representation 122 may be displayed in a separate window within dynamic user interface 150, allowing for side-by-side analysis. As another non-limiting example, second visual data point 168 and/or second visual representation 122 may be distinguished from first visual data point 148 and/or first visual representation 120 through the use of different colors, opacities, or visual techniques. In some embodiments, processor 102 may receive user input 142 from a user based on second visual representation 122. In some embodiments, second visual representation 122 may be dynamically updated in response to user input 142.

With continued reference to FIG. 1, in some embodiments, generating dynamic user interface 150 may include determining a feasibility datum 170 as a function of first execution profile 110 and second execution profile 112 and generating dynamic user interface 150 based on the feasibility datum 170. For the purposes of this disclosure, a “feasibility datum” is a data element that indicates that which execution profiles is realistic. In some embodiments, processor 102 may determine a feasibility datum based on predefined criteria, historical data, system constraints, or external factors. In a non-limiting example, processor 102 may determine feasibility datum 170 by comparing first execution profile 110 and second execution profile 112 against actual historical trends, resource availability or capability of a user (e.g., digitized representation 106 of predecessor events 108), external conditions, or other influencing parameters. As a non-limiting example, feasibility datum 170 may be calculated by analyzing past production efficiency rates, workforce availability, equipment performance, or external disruptions such as weather conditions or supply chain constraints. In a non-limiting example, if first execution profile 110 assumes continuous operations without considering scheduled maintenance (profile decrease element 140) and an urgent end date, but second execution profile 112 adjusts for downtime and an extended end date, feasibility datum 170 may indicate that second execution profile 112 is the more viable projection. In some embodiments, processor 102 may determine feasibility datum 170 using a realistic machine-learning model trained with realistic training data. In some embodiments, realistic training data may include correlations between exemplary execution profiles and exemplary feasibility data. In some embodiments, based on feasibility datum 170, processor 102 may generate dynamic user interface 150 to highlight a visual representation that is more realistic than the other. In some embodiments, dynamic user interface 150 may display maximum planned hours, maximum earned hours, maximum required hours associated with predecessor events 108 and successor events 114, and the like.

With continued reference to FIG. 1, in some embodiments, processor 102 may determine an earned datum 172. In some embodiments, generating dynamic user interface 150 may include determining an earned datum 172 as a function of execution profile and generating dynamic user interface 150 based on the earned datum 172. For the purposes of this disclosure, an “earned datum” is a data element that represents a worth of completed work. In some embodiments, earned datum 172 may be determined as a function of production output, revenue per unit, total projected earnings, or the like (e.g., first execution profile 110, second execution profile 112, and the like). In some embodiments, earned datum 172 may provide a financial assessment of a value of completed work. In some embodiments, earned datum 172 may indicate how much money can be wasted based on execution profiles and/or user input 142. In some embodiments, earned datum 172 may allow users to evaluate project profitability, budget adherence, and revenue forecasts. For instance, and without limitation, if first execution profile 110 predicts that 50% of a project will be completed within a given timeframe (temporal element 134), and the total expected revenue for the project is $1,000,000, earned datum 172 may initially be determined as $500,000. For instance, and without limitation, if second execution profile 112 with extended timeframe, processor 102 may recalculate the earned datum 172 as $400,000. Dynamic user interface 150 may then display earned datum 172.

With continued reference to FIG. 1, in some embodiments, generating dynamic user interface 150 may include determining a probability factor 174 and/or a anomaly indicating datum 176 as a function of first execution profile 110 and/or second execution profile 112 and generating dynamic user interface 150 based on the probability factor 174 and/or the anomaly indicating datum 176. For the purposes of this disclosure, a “probability factor” is a data element that represents a likelihood of achieving a specific execution profile. In some embodiments, processor 102 may determine probability factor 174 based on historical trends, external conditions, system-calculated predictions, or the like. In some embodiments, processor 102 may determine probability factor 174 by comparing first execution profile 110 and/or second execution profile 112 against historical performance data. As a non-limiting example, probability factor 174 may include a number, percentage, Boolean value, and the like. In some embodiments, processor 102 may generate feasibility datum 170 as a function of probability factor 174 and/or anomaly indicating datum 176. For example, and without limitation, if first execution profile 110 predicts a 90% project completion rate within a given timeframe, but historical data suggests that similar projects typically achieve only 75% completion under comparable conditions, processor 102 may determine that the probability factor 174 associated with first execution profile 110 is lower than that of second execution profile 112, which may reflect a more conservative estimate. In some embodiments, if user input 142 modifies resource allocation or project timelines (temporal element 134), processor 102 may recalculate probability factor 174. For the purposes of this disclosure, an “anomaly indicating datum” is a data element that quantifies a potential impact of uncertainties or deviations from expected progress. In some embodiments, processor 102 may determine anomaly indicating datum 176 based on financial exposure, resource constraints, external dependencies, or the like. As a non-limiting example, anomaly indicating datum 176 may include a text, number, percentage, Boolean value, and the like. For example, and without limitation, anomaly indicating datum 176 may include labor shortages, regulatory changes, or the like. In some embodiments, probability factor 174 and anomaly indicating datum 176 may provide an assessment of a likelihood of achieving projected outcomes (e.g., first execution profile 110 and/or second execution profile 112) and a potential impact of uncertainties. In some embodiments, dynamic user interface 150 may display probability factor 174 and/or anomaly indicating datum 176 in relation to first execution profile 110 and/or second execution profile 112. In some embodiments, processor 102 may generate probability factor 174 and/or anomaly indicating datum 176 using a factor machine-learning model trained with factor training data. In some embodiments, factor training data may include correlations between exemplary execution profiles, exemplary probability factors and/or exemplary anomaly indicating datums. In some embodiments, user may manually determine probability factor 174 and/or anomaly indicating datum 176.

With continued reference to FIG. 1, in some embodiments, processor 102 may classify a representation label 162 to visual representations (e.g., first visual representation 120, second visual representation 122, and the like) and store the labeled visual representations into event database 130. In some embodiments, any associated factors, parameters, inputs, future durations, and the like of labeled visual representations may be stored in event database 130. In a non-limiting example, when a specific labeled visual representation is retrieved from event database 130 as a function of user's query, associated metadata may be retrieved as well. In some embodiments, user may manually label visual representations. In some embodiments, user may query a specific visual representation as a function of a representation label 162. For example, and without limitation, if first visual representation 120 is labeled as ‘Representation A,’ user may query ‘Representation A’ to be displayed on dynamic user interface 150. For example, and without limitation, if first visual representation 120 with 10 days future duration is labeled as ‘D10’ or ‘Scenario 1,’ user may query ‘D10’ or ‘Scenario 1’ to be displayed on dynamic user interface 150. In some embodiments, user input 142 may include a representation label 162. In a non-limiting example, user may input representation label 162 through user input field 164. In a non-limiting example, user may select a specific representation label 162 from a list of representation labels 162 in a drop down menu. In some embodiments, dynamic user interface 150 may include representation label 162. In some embodiments, processor 102 may label visual representations using a classifier trained with classification training data. As a non-limiting example, classification training data may include correlation between visual representations and representation labels.

With continued reference to FIG. 1, in some embodiments, additional disclosure related to apparatus 100 and/or any computation or method may be found in U.S. Nonprovisional patent application Ser. No. 18/516,421, filed on Nov. 21, 2023, titled “APPARATUS AND METHOD FOR COMPUTER-IMPLEMENTED MODELING OF MULTIEVENT PROCESSES,” having an attorney docket number of 1597-001USU1, and U.S. Nonprovisional patent application Ser. No. 17/991,432, filed on Nov. 21, 2022, titled “COMPUTER-IMPLEMENTED PROGRESS MODELING OF MULTI-EVENT PROCESS,” having an attorney docket number of 1597-002USU1, the entirety of each of which is incorporated herein as a reference.

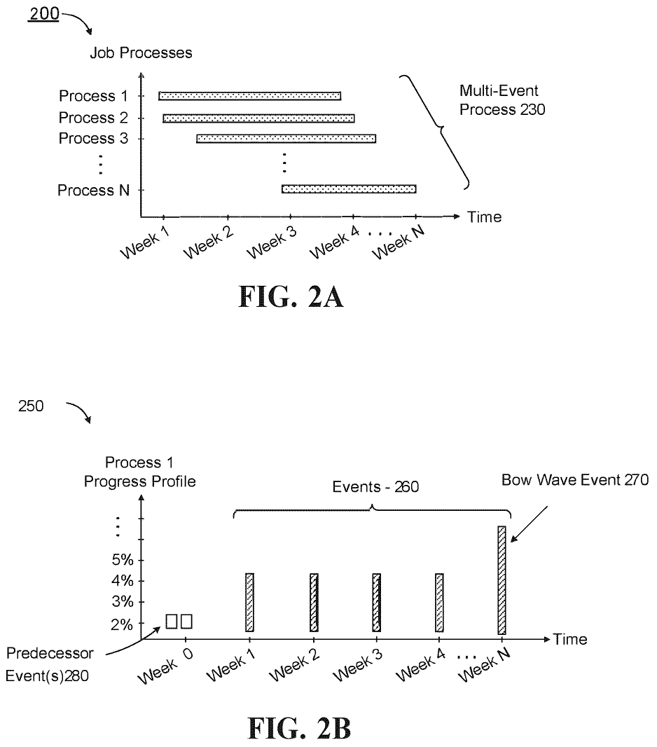

Now referring to FIG. 2A, an exemplary embodiment of a graph 200 showing job processes in a schedule of a multi-event process to be performed at various points in time is illustrated. As depicted in FIG. 2A, the vertical axis depicts job processes, and the horizontal axis depicts time in weeks. Thus, as shown, process 1 initiates at week 1 and completes at week 4. Process 2 is shown as initiating at week 1 slightly after process 1 and completing at week 4, slightly after completion of process 1. Process 3 is shown as initiating at a middle point of week 1 and completing at a middle point of week 4. It should be understood that processes of FIG. 2A may include any number of processes similar to processes 1, 2, and 3, such as 10 processes, 20 processes, hundreds of processes, or even thousands of job processes. Accordingly, process N may represent any number of processes of a multi-event process, virtually without limitation.

With continued reference to FIG. 2A, processes of multi-event process 230 are intended to reflect discrete processes of any type of multi-event process. Thus, process 1 may refer to, for example, excavation, such as excavation in preparation for constructing a road or highway. Process 2, for example, may refer to hauling excavated earth from a construction site, while process 3, for example, may refer to surveying of excavated areas in preparation for depositing a capping layer, over which asphalt and other materials may be deposited. Processes 1, 2, 3, . . . , N are intended to comprise “discrete events,” which, for the purpose of this disclosure, refer to one or more discrete occurrences, which may be performed over a period of days, weeks, months, years, or any other discrete period of time. Thus, in a possible example, process 1 may involve excavating, which comprises 4 weekly events of removal of 25% of a total area (or volume) to be excavated.

With continued reference to FIG. 2A, apparatus described herein may further enhance the fluidity of such scheduling process. In some embodiments, multi-event process model may be configured to dynamic adjust the schedule based on one or more event attributes such as, without limitation, a start time and a finish time of any given process within the multi-event process. In some embodiments, start time and a finish time may include a start date 136 and finish date, respectively. For instance, and without limitation, if the finish date of a Process 1 (e.g., excavation) is extended by one week, multi-event process model may automatically adjust the subsequent process, such as a Process 2 (e.g., hauling excavated earth) and a Process 3 (surveying), to align with such change. Thus, in a non-limiting example, such adjustment may be akin to an accordion effect, wherein the extension or compression of one process's duration proportionally affects the durations of subsequent processes.

Continuing reference to FIG. 2A, in some cases, apparatus described herein may allow a user to input a change in one or more event attributes e.g., either a start time or a finish time for any process within the multi-event schedule. Upon receiving user input, multi-event process model may recalculate durations for remaining processes. In one or more embodiments, recalculation may not be merely a linear adjustment; rather, multi-event process may be configured to intelligently consider a plurality of interdependencies of event attributes (i.e., characteristics) of each process. Thus, in a possible example, if Process 1's duration is extended, multi-event process model may adjust the start and finish date of Process 2 and Process 3 accordingly to maintain the integrity and feasibility of the multi-event process.

Still referring to FIG. 2A, additionally, event execution profiles for each process may be updated, in real-time or in near-real-time. In some cases, these updated profiles may be used to compute new production figures or contractor counts required to achieve the revised start and/or finish dates. In a context of a complex projects where multiple processes are interdependent, such dynamic adjustment—a change in one process can have cascading effects on others, may be particularly beneficial to multi-event process model to instantly reflect one or more changes in event attributes and/or event execution profiles and their corresponding visual representations (as per FIG. 2A and subsequent FIGS. 2B-4 and 8-19 as described below) for efficient project management, allowing project teams to promptly access and adapt to schedule changes.

With continued reference to FIG. 2A, in a non-limiting example, visual representation of the multi-event process may include a Gantt chart. When a user modifies the start or finish date of multi-event process 230, such as extending Process N's duration, multi-event process model may intelligently adjust the duration of one or more process over a future duration. Accordingly, in some instances, such adjustment may be graphically depicted as extending or shrinking the corresponding progress bar on the chart to maintain the project timeline while accommodating the new date. As shown in FIG. 2A, the depicted Gantt chart is capable of dynamically representing the accordion effect. User may see the immediate impact of changes on the schedule. In some cases, multi-event process model may be configured to recalculate durations of Processes 1-3 based on modified finish date of Process N, such as, increase (postpone) or decrease (advance) the finish dates of Processes 1-3 and update the Gantt chart in real-time or near-real-time. As such, the Gantt chart may become an interactive tool, not just for planning but also for managing ongoing changes in the project lifecycle. In a particular embodiment, the Gantt chart's fluidity may allow user to input a single event attribute modification (e.g., date change) and have the entire schedule automatically update accordingly.

Now referring to FIG. 2B, an exemplary embodiment of a graph 250 showing a execution profile of process events over a period of weeks is illustrated. As depicted in FIG. 2B, the vertical axis depicts a execution profile of process 1, which may occur via weekly events 260 spread over weeks 1-N. As shown, events 260 represent a weekly completion rate of approximately 4% per week at least through weeks 1-4. However, as is also shown in FIG. 2B, an accumulation of the effects of a execution profile reflecting completion of process events 260 of 4% over a 4-week period leads to bow wave event 270, which indicates that the contractor must make progress at a rate of more than 6% per week at week N, so as to reflect 200% completion of the process at week N. As noted previously herein, such bow wave events can be avoided via timely replanning/rescheduling via computer-implemented modeling of multi-event processes. Further, in particular embodiments, computer-implemented modeling of a multi-event process may facilitate the interactive real-time or near-real-time modeling of the events of a process, so as to warn a contractor and other concerned parties of an impending, and potentially unmanageable, bow wave of progress at week N.

With continued reference to FIG. 2B, predecessor event 280 may impact completion of events 260 of a scheduled process. In particular embodiments, predecessor event 280 may refer to one or more previous events of a process similar to process events 260. Accordingly, predecessor event 280 may refer to a percentage of a completion state of events similar to those of events 260. Thus, for example, predecessor event 280 may represent an accumulation of one or more events, such as excavating earth, similar to events 260 that may also pertain to excavating earth. In this context, predecessor event 280 may represent a plurality of past weekly events. For example, predecessor event 280 may indicate progress to date of excavation during several past weeks during a flood season, in which only marginal clean progress has been made toward excavating a total area or volume of earth that is to be excavated.

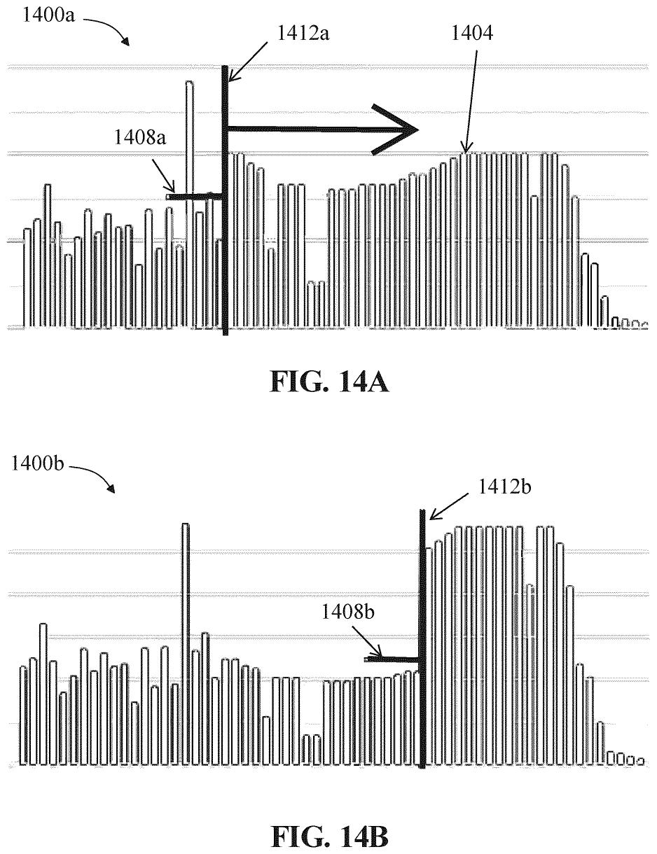

With continued reference to FIG. 2B, in some cases, computer-implemented modeling tool may incorporate one or more machine learning algorithms (as described in further detail with reference to FIG. 14 below) that analyze historical scheduling and performance data. In some embodiments, implementations of one or more machine learning algorithms may enable multi-event process models to learn from past project executions, identifying one or more scheduling/event execution patterns and correlations that may predict future scheduling i.e., second subset of events of plurality of events, events conflicts, resource needs, and/or the like. In a non-limiting example, training data containing project data related to a plurality of historical projects that involved one or more processes in questions, apparatus described herein may be configured to implement a machine learning model e.g., a random forest machine learning model using such training data. Thus, in a possible example, trained random forest machine learning model may be capable of analyzing various factors that influence project timelines such as, without limitation, weather patterns, crew size, equipment availability, among other potential factors. According to a particular embodiment, such machine learning model may have learned from, for example, previous projects that rainy seasons can delay the process of pouring of concrete for foundations, could proactively suggest or generate an adjustment or a set of adjustments (or an alternative schedule) to the calculated schedule or replace it. If, in some instances, the upcoming project timeline falls in a period known for high precipitation, computer-implemented modeling tool may automatically propose an earlier start time for a foundation work or recommend allocation of additional resources to maintain the timeline despite potential weather disruptions using machine learning models.

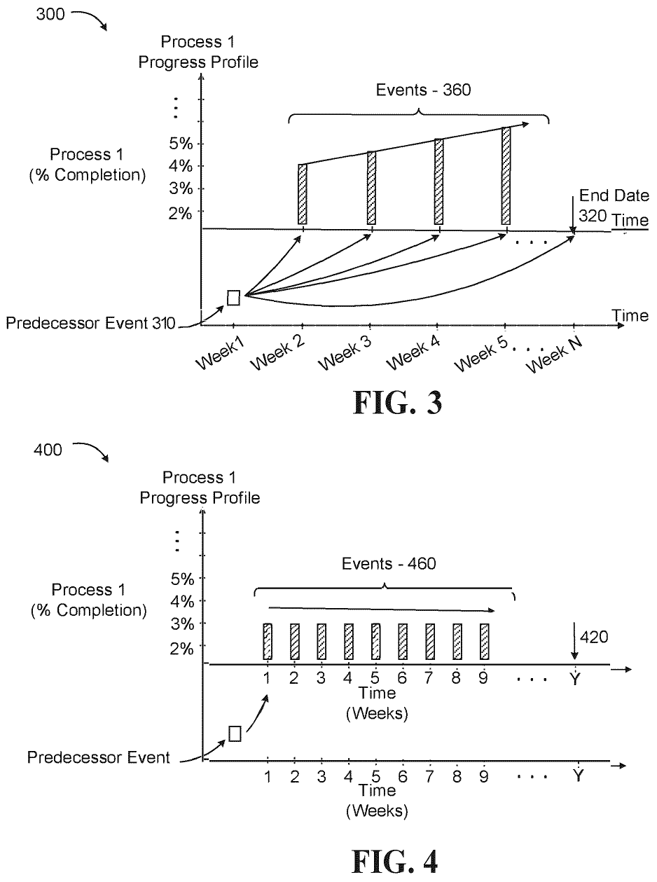

Now referring to FIG. 3, an exemplary embodiment of a graph 300 showing respreading of process events in response to delayed completion of a predecessor second event is illustrated. In this embodiment, events 360 represent a respreading of events 260 (of FIG. 2B). Such respreading operates to avoid bow wave event 270 shown in FIG. 2B. Thus, as shown, in response to a contractor incrementally increasing a rate of progress of events 260, the contractor may avoid potentially unmanageable bow wave event 270. In the example of FIG. 3, responsive to a contractor increasing the rate of progress of events 260, such as from approximately 3% at week 2 to approximately 5% at week 5, the contractor may be assured that the process that includes events 260 may be completed by an end date, given by arrow 320 at week N. Such increases in the rate of progress may be brought about by increasing a performance factor of events 260, which may include adding personnel and/or equipment resources, engaging a specialized sub-tier contractor, and so forth.

With continued reference to FIG. 3, additionally depicts predecessor event 310, which may refer to an event of a process that is different from a process encompassing events 260. For example, predecessor event 310 may refer to one or more inspections, which may be scheduled to occur prior to initiation of time-phased events 260. In one possible scenario, prior to excavation of material from a jobsite, one or more environmental impact studies may be scheduled for submittal and/or approval, which may delay excavation events 260. However, by way of a computer-implemented model of a multi-event process, a contractor, overseer, or other interested party, may visually represent a revised execution profile of events 260, so as to avoid bow wave 270 of FIG. 2B by increasing weekly progress by incremental amounts.

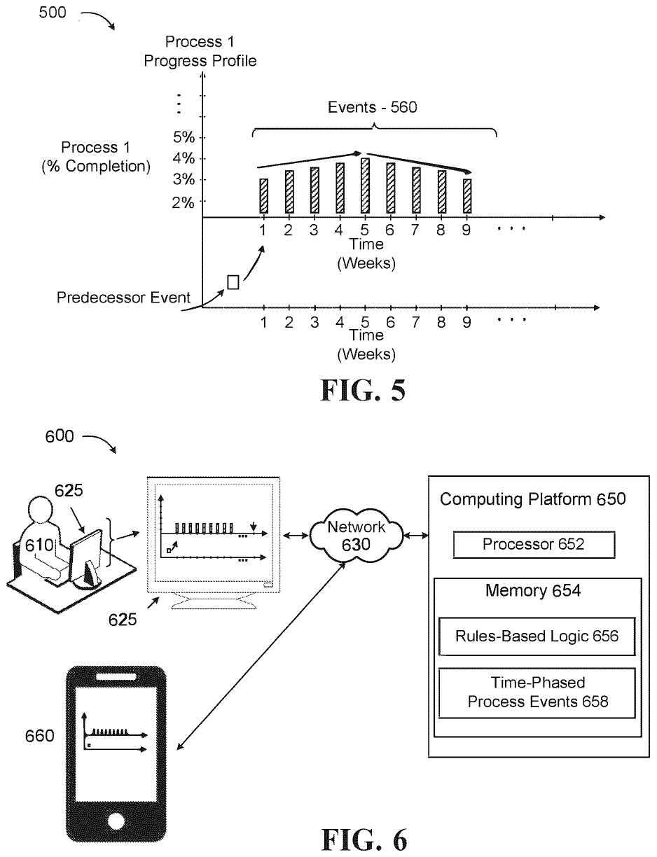

Now referring to FIG. 4, an exemplary embodiment of a graph 400 showing respreading of process events in response to delayed completion of two predecessor process events is illustrated. In FIG. 4, rather than increasing a rate of completion of time-phased process events, such as depicted in reference to FIG. 3, time-phased events 460 may be spread to reflect a completion rate of 3% per week over a duration of greater than 9-weeks. Such respreading of time-phased events over a longer duration (e.g., greater than 9-weeks) may avoid a need for an increased rate of completion of process events, which may be, at least in particular instances, difficult to achieve. However, such respreading of time-phased events, as shown, delays completion of events 460, in which a completion date has been moved to end date 420. It may be appreciated that such computer-implemented modeling of a multi-event process may be instrumental in providing real-time or near-real-time notification that a completion date for certain events may extend beyond the previously-scheduled completion date.

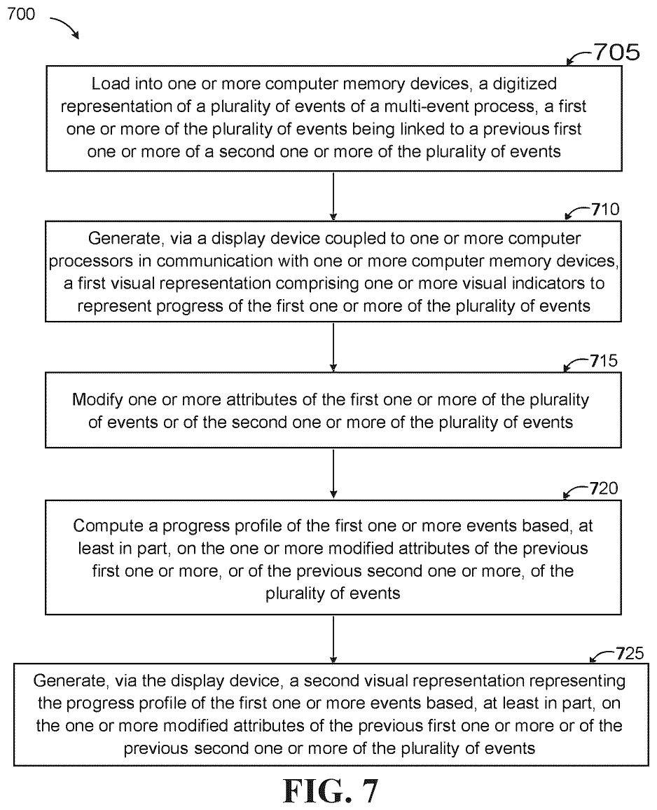

Now referring to FIG. 5, an exemplary embodiment of a graph 500 showing respreading of process events in response to completion of a predecessor event, in which process completion rates are first increased and then later decreased, is illustrated. Thus, as indicated in FIG. 5, a completion rate of time-phased events 560 may be scheduled to increase from a completion rate of approximately 3% per week at week 1 to a completion rate of approximately 4% at week 5 before returning to a completion rate of approximately 3% at week 9.

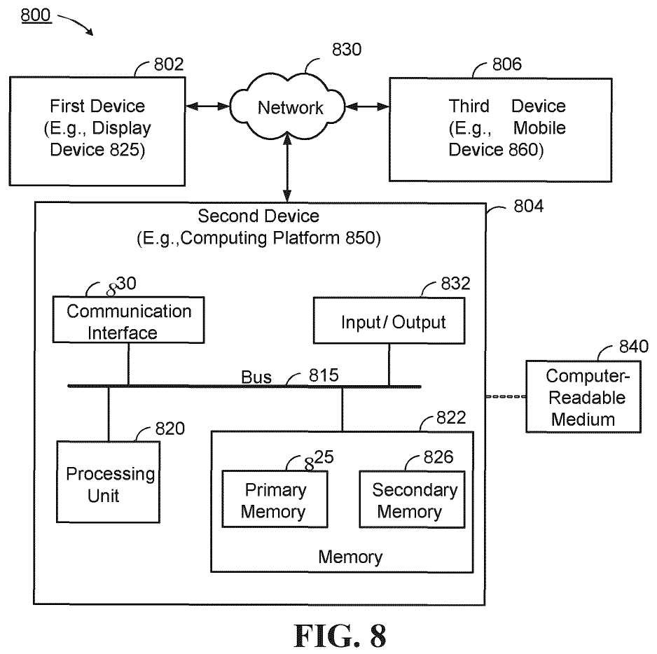

Now referring to FIG. 6 a schematic diagram 600 showing a user interacting with a user interface to utilize a computer-implemented model of a multi-event process is illustrated. In FIG. 6, user 610 may interact with computing platform 650, such as via intervening network 630, to perform real-time or near-real-time replanning and/or rescheduling events of a particular process of the multi-event process. Accordingly, user 610 may generate, for example, numerous formal or informal speculations based on virtually any number of scenarios, for example, in completing scheduled events of a multi-event process. Display device 625 may operate to display visual representations of any graphs previously discussed with respect to FIGS. 1-20 herein. In addition, display device 625 may permit user 610 to select to display visual representations of graphs graduated to show time-phased events representing daily progress, weekly progress, monthly progress, or any other user-selectable graduation of time-based events, and claimed subject matter is not limited in this respect.

It should be noted that although FIGS. 1-20 relate to computer-implemented models of a multi-process event within the context of a construction project, it may be appreciated that such embodiments, or other embodiments, may relate to a variety of other industries. For example, within a financial context, an individual or an entity may allocate certain financial resources in accordance with an originally-proposed set of time-phased events, such as $1100 per month. However, in the event that actual allocations (e.g., one or more predecessor events) fall short (e.g., allocating only $850 per month) a computer-implemented model may alert a financial officer, for example, that monthly allocation events are to be increased in order to reach an end goal that relates to a total allocation of financial resources. In another example, with respect to a business entity engaged in selling products, an originally proposed sales schedule may forecast sales of 1100 units per month. However, responsive to actual sales (predecessor events) falling short of forecast sales (e.g., sales of only 600 units per month) a sales manager may be alerted so as to increase sales efforts over future months so as to realize particular sales of total units by a future date.

Computing platform 650 of FIG. 6 may comprise one or more of processor 652, which may be communicatively coupled to one or more memory devices, such as memory 654. Memory 654 may comprise a memory array, such as a two- or three-dimensional memory array, which may be loaded so as to implement rules-based logic 656. Rules-based logic 656 may operate to link various time-phased process events, such as time-based process events 658. In particular embodiments, processor 652 may execute a computer program to implement a spreadsheet application so as to facilitate display and/or evaluation of virtually any number of originally proposed or respread process events, such as those described previously herein.

In an embodiment, user 610 may interact with a spreadsheet application operating on mobile device 660, which may facilitate the same or similar interactions performed via a user interface of computing platform 650. Thus, mobile device 660 may cooperate with computing platform 650 to implement rules-based logic to display originally proposed and/or respread events of a multi-event process. In another embodiment, mobile device 660 may include a suitable processor coupled to a memory device to implement rules-based logic to display original and/or respread events in a standalone manner, such as without aid or cooperation with computing platform 650.

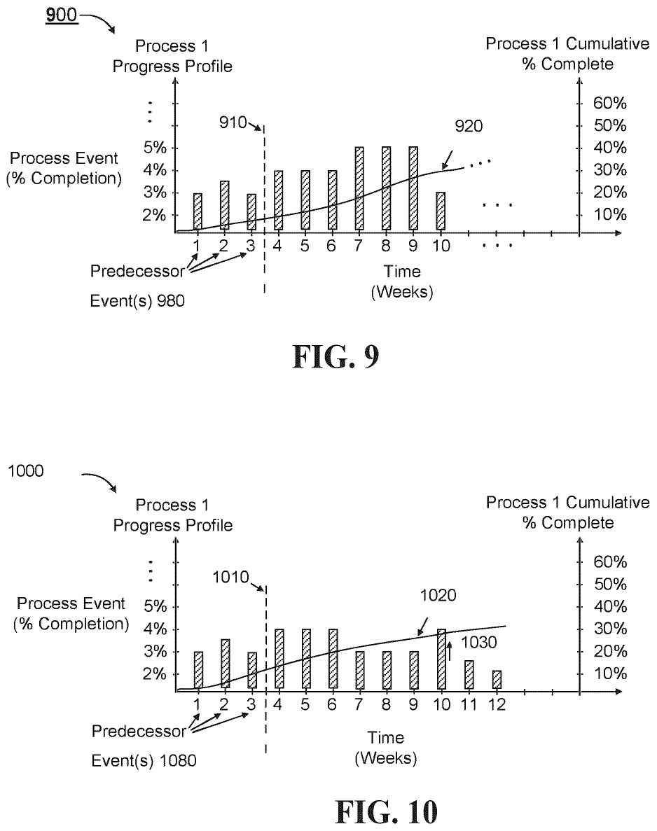

Now referring to FIG. 7, a flowchart for a method 700 for computer-implemented modeling of a multi-event process is illustrated. Embodiments in accordance with claimed subject matter may include all of the actions depicted at 705-725, fewer actions than those depicted at 705-725 and/or more actions than those depicted at 705-725. Likewise, it should be noted that content acquired or produced, such as, for example, input signals, output signals, operations, results, etc., brought about by the example process of embodiment may be represented via one or more digital signals and/or digital signal states. It should also be appreciated that even though one or more operations are illustrated or described concurrently or with respect to a certain sequence, other sequences or concurrent operations may be performed. In addition, although the description below references particular aspects and/or features illustrated in certain other figures, one or more operations may be performed with other aspects and/or features. In embodiments, blocks 705-725 may be communicated as one or more signals and/or signal packets among various software, firmware and/or hardware services executed at a computing device, such as computing platform 650.

With continued reference to FIG. 7, method 700 may begin at 705, which may include loading into one or more computer memory devices, a digitized representation of a plurality of events of a multi-event of process. A first sub-set of events are linked to a sub-set of previous (historical) events. Alternatively, at 705, first sub-set of events may be linked to a second sub-set of events of the plurality of events. The method 700 may continue at 710, which may include generating a first visual representation, such as via a display device coupled to one or more computer processors in communication with one or more computer memory devices, one or more visual data points to represent progress of the first plurality of the plurality of events.

With continued reference to FIG. 7, in some embodiments, first visual representation and second visual representation may be determined as a first visual representation data structure and a second visual representation data structure, respectively. A “visual representation data structure,” for the purposes of this disclosure, is a data structure containing information relating to a visual representation, wherein the data structure is configured to cause a remote device to display the visual representation. In some embodiments, visual representation data structures may include code such as CSS or HTML. In some embodiments, visual representation data structures may include one or more event handlers, wherein the event handlers are configured to execute code in response to a given event. In some embodiments, first and/or second visual representation data structures may be transmitted to one or more remote devices.

With continued reference to FIG. 7, method 700 may continue at 715, which may include modifying one or more event attributes of the first one or more of the plurality of events or of the second of the one or more of the plurality of events. The method 700 may continue at 720, which may include computing an event execution profile of the first one or more events based, at least in part, on the one or more modified event attributes (e.g., as modified in accordance with 715) of the first one or more, or of the second one or more, of the plurality of events. The method may continue at 725, which may include generating a second visual representation, via the display device, based, at least in part, on the one or more modified attributes of the first one or more or of the second one or more of the plurality of events.

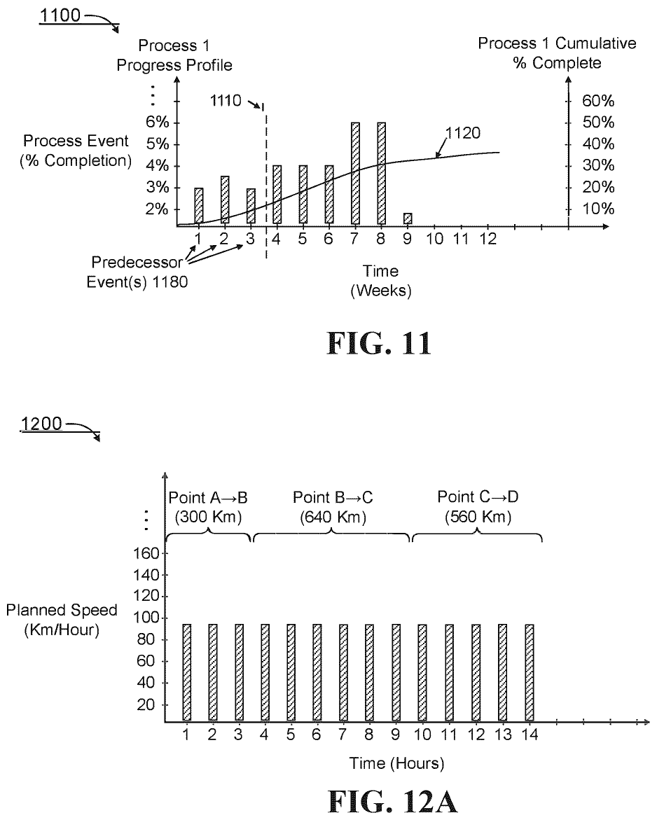

Now referring to FIG. 8, a schematic block diagram illustrating a computing environment 800 to facilitate computer-implemented modeling of a multi-event process is illustrated. In the embodiment of FIG. 8, first device 802 may comprise a computer user interface and a display device, such as display device 625 of FIG. 6. Second device 804, may comprise, for example, computing platform 650, which may permit the user to interact with a spreadsheet program, for example, to facilitate modeling of a multi-event process. Third device 806 may comprise a mobile device, such as mobile device 660, which may include a user interface, a computer processor, and one or more computer memory devices, to allow the user, such as user 610, to interact with a spreadsheet program, for example, which may facilitate modeling of a multi-event process. Network 630 may comprise any type of ethernet, LAN, or Internet-based computing network, similar to network 630 of FIG. 6. Processing unit 820 and memory 822, which may comprise primary memory 825 and secondary memory 826, may communicate by way of a communication interface 830, for example, and/or input/output module 832. The terms “computing device,” “computing platform,” or “computing resource” in the context of the present application, refer to a system and/or a device, such as a computing apparatus that includes a capability to process (e.g., perform computations) and/or store digital content, such as electronic files, electronic documents, text, images, video, audio, etc., in the form of signals and/or signal states. Thus, a computing platform, in the setting or environment of the present patent application, may comprise hardware, software, firmware, or any combination thereof (other than software per se). Computing device 804 (e.g., second device), as depicted in FIG. 8, is merely one example, and claimed subject matter is not limited in scope to this particular example.

With continued reference to FIG. 8, computing device includes a processor communicatively connected to a memory. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 8, first device 802, second device 804, and third device 806 may provide one or more sources of executable computer instructions in the form of physical states and/or signals (e.g., stored in memory states), for example. First device 802 may communicate with second device 804 by way of a network connection, such as via network 630 as previously mentioned, for example. It may be appreciated that a connection, while physical, may be virtual and not necessarily be tangible. Although second device 804 of FIG. 8 depicts various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

With continued reference to FIG. 8, memory 822 may comprise any non-transitory storage device or system of devices. Memory 822 may comprise, for example, primary memory 825 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Continuing reference to FIG. 8, memory 822 may comprise one or more articles utilized to store a program of executable computer instructions. For example, processing unit 820 may fetch executable instructions from memory and proceed to execute the fetched instructions. Memory 822 may also comprise a memory controller for accessing computer-readable medium 840 that may carry and/or make accessible digital content, which may include code, and/or instructions, for example, executable by processing unit 820 and/or any other device, such as a controller, as one example, capable of executing computer instructions, for example. Under direction of processing unit 820, a non-transitory memory, such as memory cells storing physical states (e.g., memory states), comprising, for example, a program of executable computer instructions, may be executed by processing unit 820 and be capable of generating signals to be communicated via a network, for example, as previously described. Generated signals, and/or signal states, may also be stored in memory, also previously suggested.

With continued reference to FIG. 8, memory 822 may store electronic files and/or electronic documents, such as relating to one or more users, and may also comprise a machine-readable medium that may carry and/or make accessible content, including code and/or instructions, for example, executable by processing unit 820 and/or any other type of programmable device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document, such as a spreadsheet. That is, it is not meant to implicitly reference a particular syntax, format and/or approach used, for example, with respect to a set of associated memory states and/or a set of associated physical signals. It may be appreciated that an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

With continued reference to FIG. 8, Example devices may comprise features, for example, of a client computing device and/or a remote/server computing device, in an embodiment. It is further noted that the term computing device, in general, whether employed as a client and/or as a server, or otherwise, refers at least to a processor and a memory connected by communications bus 815. A “processor,” such as a processor of a computing platform, for example, is understood to refer to a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 212 (f) so that it is specifically intended that 35 USC § 212 (f) not be implicated by use of the term “computing device,” “processor,” “computing platform,” and/or similar terms; however, if it is determined, for some reason not immediately apparent, that the foregoing understanding cannot stand and that 35 USC § 212 (f), therefore, necessarily is implicated by the use of the term “computing device,” “processor,” computing platform,” and/or similar terms, then, it is intended, pursuant to that statutory section, that corresponding structure, material and/or acts for performing one or more functions be understood and be interpreted to be described in the figures shown and described herein.

With continued reference to FIG. 8, processor may include any computing device as described in this disclosure, including without limitation a microcontroller, microprocessor, digital signal processor (DSP) and/or system on a chip (SoC) as described in this disclosure. Processor may include, be included in, and/or communicate with a mobile device such as a mobile telephone or smartphone. Processor may include a single computing device operating independently, or may include two or more computing device operating in concert, in parallel, sequentially or the like; two or more computing devices may be included together in a single computing device or in two or more computing devices. Processor may interface or communicate with one or more additional devices as described below in further detail via a network interface device. Network interface device may be utilized for connecting processor to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor may include but is not limited to, for example, a computing device or cluster of computing devices in a first location and a second computing device or cluster of computing devices in a second location. Processor may include one or more computing devices dedicated to data storage, security, distribution of traffic for load balancing, and the like. Processor may distribute one or more computing tasks as described below across a plurality of computing devices of computing device, which may operate in parallel, in series, redundantly, or in any other manner used for distribution of tasks or memory between computing devices. Processor may be implemented, as a non-limiting example, using a “shared nothing” architecture.

With continued reference to FIG. 8, processor may be designed and/or configured to perform any method, method step, or sequence of method steps in any embodiment described in this disclosure, in any order and with any degree of repetition. For instance, processor may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

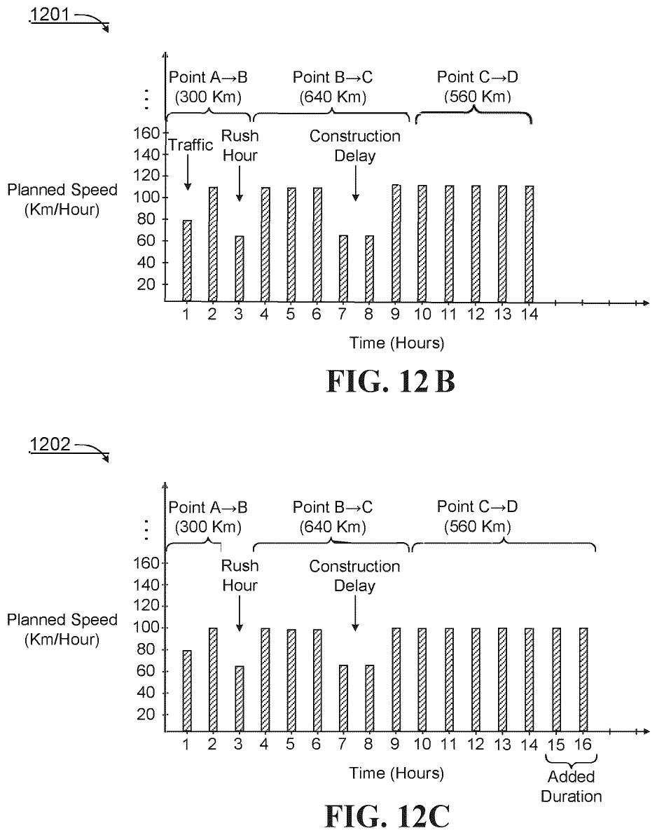

Now referring to FIG. 9, a first exemplary embodiment of a graph 900 showing respreading of process events in response to linking of a computer-implemented model for a multi-event process with a computer-implemented calendaring tool. In the embodiment of FIG. 9, predecessor events 980 of a multi-event process are indicated as being prior to dotted line 910, which separates preceding (actual) events from events scheduled to occur during a future duration. A execution profile of process 1 (in percentages) is indicated at the vertical axis at the left side of FIG. 9, and a measure of cumulative progress toward completion is indicated at the vertical axis at the right side of FIG. 9. Line 920 indicates a measure of cumulative progress so as to account for incremental (e.g., weekly) progress toward completion of process 1.

With continued reference to FIG. 9, events occurring at weeks 4, 5, and 6 may be constrained to correspond to a completion rate of 4% per week. Additionally, events occurring at weeks 7, 8, and 9 may be constrained to correspond to a completion rate of 5% per week. In particular embodiments, such constraints may be realized by linking, for example, a computer-implemented spreadsheet with a computer-implemented calendaring tool. In such a scenario, in view of constraints placed upon rates of completion at weeks 4-7, a computer-implemented model of a multi-event process may respread events beginning at week 10, so as to indicate a desired a cumulative completion of approximately 30% at week 10 and beyond. It may be appreciated that such linking of a computer-implemented spreadsheet with a calendaring tool may facilitate generation of a respread execution profile that permits the user (e.g., user 610 of FIG. 6) to impart a particular shape or form to line 920 in a way that may be useful to a contractor or to a contracting officer, a customer, or other overseer. In addition, respreading of events of a execution profile may be computed and/or represented to show increasing rates of progress over time (e.g., “ramp up”) as well as decreasing rates of progress (e.g., “ramp down”). Moreover, responsive to establishing rules-based logic, such as via rules-based logic 656 of FIG. 6, a user may be able to establish logical links between calendaring events and time-phased events.

Table 2 (below) depicts entries to a computer-implemented spreadsheet showing weekly progress events linked to a computer-implemented calendaring program to indicate a contractor performance Index (CPI) of 1.0 as a spread among weeks 4-9.

TABLE 2

| CPI | | | | | | |
|---|---|---|---|---|---|---|
| Adjustment | Week 4 | Week 5 | Week 6 | Week 7 | Week 8 | Week 9 |
| 1.0 | 4.0% | 4.0% | 4.0% | | | |
| 1.0 | | | | 5.0% | 5.0% | 5.0% |

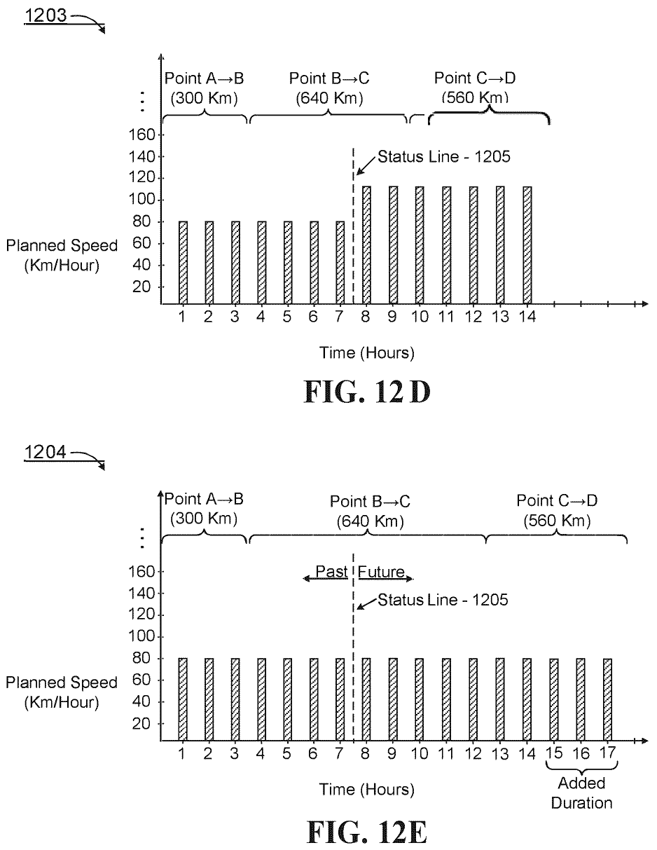

Now referring to FIG. 10, a second exemplary embodiment of a graph 1000 showing respreading of process events in response to linking of a computer-implemented model for a multi-event process with a computer-implemented calendaring tool is illustrated. In the embodiment of FIG. 10, predecessor events of a multi-event process are indicated as being prior to dotted line 1010, which separates preceding (actual) events from events scheduled to occur during a future duration. A execution profile of process 1 (in percentages) is indicated at the vertical axis at the left side of FIG. 10, and a measure of cumulative progress toward completion is indicated at the vertical axis at the right side of FIG. 10. Line 1020 indicates a measure of cumulative progress so as to account for incremental (e.g., weekly) progress toward completion of process 1.

With continued reference to FIG. 10, events occurring at weeks 4, 5, and 6 may be constrained to correspond to a completion rate of 4% per week. Additionally, events occurring at weeks 7, 8, and 9 may be constrained to correspond to a completion rate of 3% per week. In particular embodiments, such constraints may be realized via linking, for example, a computer-implemented spreadsheet with a computer-implemented calendaring tool. In such a scenario, in view of constraints placed upon rates of completion at weeks 4-9, a computer-implemented model of a multi-event process may respread events beginning at week 10, to achieve a desired a cumulative completion of approximately 30% at week 12. In the embodiment of FIG. 10, in response to constraining completion rates at weeks 4-9, a computer-implemented model may respread events beginning at week 10 and decreasing (e.g., ramping down) at weeks 10, 11, and 12.

With continued reference to FIG. 10, in addition, a computer-implemented model for a multi-event process utilizing a computerized spreadsheet may apply a CPI having values other than 1.0, as shown in Table 2 (above). Accordingly, as indicated in Table 3 (below), a CPI of 0.75 may be applied to reduce expected actual progress to accord with a CPI of below 1.0, so as to account for, for example, an anticipated adverse weather impact, holiday, or other occurrence that operates to reduce a weekly progress rate of a particular process event. Thus, as shown in Table 3 (below) similar to a CPI at weeks 4, 5, and 6 shown in Table 2 (without expected weather delays), for example, a contractor may schedule progress in accordance with a CPI of 1.0. However, in anticipation of a scheduled local holiday, a execution profile of weekly events occurring at weeks 7, 8, and 9 a CPI may be reduced from 1.0 to, for example, 0.75. Thus, as indicated in Table 3 below, and in FIG. 10, an execution profile of events occurring at weeks 7, 8, and 9 is indicated as being reduced to 3%.

TABLE 3

| CPI | | | | | | |
|---|---|---|---|---|---|---|
| Adjustment | Week 4 | Week 5 | Week 6 | Week 7 | Week 8 | Week 9 |
| 1.0 | 4.0% | 4.0% | 4.0% | | | |
| 0.75 | | | | 3.0% | 3.0% | 3.0% |

Continuing reference to FIG. 10, in addition, FIG. 10 indicates that responsive to a reduction in a CPI from 1.0 to 0.75, a weekly progress rate of an event occurring at week 10 may be indicated as increasing, as shown by arrow 1030. A progress rate of the event may then ramp down, such as indicated with respect to weeks 11 and 12. It may be appreciated that responsive to a reduced CPI at weeks 7-9, a period of performance may be extended into weeks 11 and 12 (and perhaps beyond).

With continued reference to FIG. 10, additionally, or alternatively, respreading of progress events i.e., events subsequent to predecessor events 1080 may include a utilization of an “event attribute modifier,” wherein the “event attribute modifier,” for the purpose of this disclosure, a feature or a set of features in computing platform 650 that allows a user to change event attributes associated with events within a schedule. In one or more embodiments, event attribute modifier may control one or more event attributes associated with one or more events, for example, event attributes may be controlled may include, but are not limited to, the start and end dates of one or more events, progress status, event dependencies, and other parameters.

Still referring to FIG. 10, event attribute modifier may include, according to a particular embodiment, a linear element such as a linear a graphical user interface element within the user interface. In some cases, such linear graphical user interface element may include, without limitation, a slider bar, dropdown menu, or a input field. In a non-limiting example, event attribute modifier may be embodied as a linear element that is designed with a first interactive end and a second interactive end, corresponding respectively to a changeable start time of a first event and a changeable end date of a second event. In some cases, first interactive end may also correspond to a changeable end date of a predecessor event. User may actively manipulate the linear element to adjust the scheduling of events. In some cases, user may move the slider bidirectionally until the respread event execution matches historical data points. Such alignment may signify that the adjusted forecast for the project mirrors the level of work and progress rates achieved in previous projects under similar conditions.

With continued reference to FIG. 10, in a non-limiting example, in some cases, project that is scheduled across week 1 to week 10 (as shown in FIG. 9) may project a 25% completion by week 10 due to unexpected delays in predecessor events 980. Thus, in a possible example, user may use slider bar within the computer-implemented tool to adjust event attributes of events for week 4 to 10. In some cases, slider bar presented on the user interface may include a first interactive end represent the start time of event at week 4 (i.e., process 4) and a second interactive end represents the end date (initially set at week 10) of the project. User may drag the second interactive end of the slider bar outward, extending the end date of the project. As the slider moves, multi-event process model may recalculate the completion rate needed each week to meet 30% milestone by week 12 (as shown in FIG. 10). User may continue to adjust slider bar and the visual representation may dynamically update according to the adjustment. In an embodiment, line representing the cumulative progress (line 1020) may alter its trajectory, ramping up to meet historical completion rate. Once the slider bar is released, multi-event process model may lock in the new end date, and a second visual representation may be generated to reflect an adjusted schedule where progress of events of subsequent weeks is flattened (due to an increase in week numbers).

With further referring to FIG. 10, additionally, or alternatively, in scenarios where project constraints dictate, for example, a maximum allowable resource level, event attribute modifier may be utilized to ensure that the project schedule adheres to such limitations. In a non-limiting example, if a construction project area can only accommodate a maximum of 50 workers at any given time, and the current schedule indicates a requirement for 75 workers, user may use slider bar to adjust project timeline accordingly by slide second interactive end (finish date) outward, multi-event process model may recalculate the distribution of work such that at no points does the worker requirement exceed the maximum capacity of 50 works. Thus, this respreading of events may, in turn, indicate a more realistic duration for each event given the resource constraints.

Continuing reference to FIG. 10, according to an alternative embodiment, computer-implemented model for multi-event process may provide one or more input fields wherein user may specify one or more event limitations or constraints such as, without limitation, maximum number of workers. In some cases, upon entry, the multi-event process model may automatically extend the end date of one or more events in question until the calculated requirement for workers does not surpass the maximum input. In some cases, such feature may automate the process of verifying a compliance with project resource constraints, thereby streamlining project scheduling and management. Additionally, apparatus described herein may incorporate probability ranges into the multi-event process model; for instance, if there is a 90% probability (P90) that the project can efficiently manage 40 workers, such figure may be entered, by a user, into the computer-implemented tool as a maximum constraint. Similarly, a 50% probability (P50) may correspond to 50 workers, and a 10% probability (P10) to 60 workers. In this case, multi-event process model may use these probability inputs to automatically adjust the project schedule, displaying different potential completion dates (P90, P50, and P10 dates) for each probability level

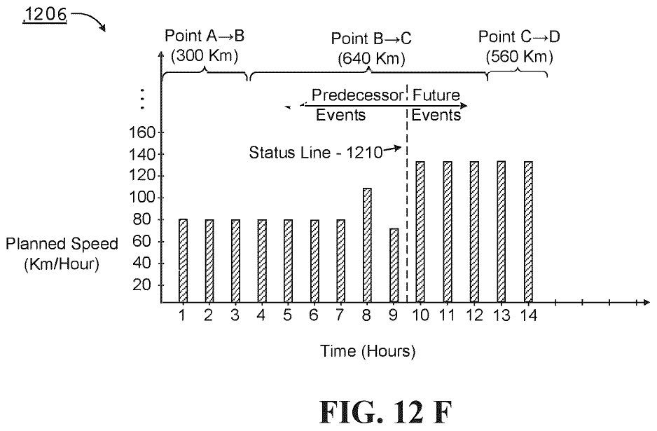

Now referring to FIG. 11, a third exemplary embodiment of a graph 1100 showing respreading of process events in response to linking of a computer-implemented model for a multi-event process with a computer-implemented calendaring tool is illustrated. In the embodiment of FIG. 11, predecessor events 1180 of a multi-event process are indicated as being prior to dotted line 1110, which separates preceding (actual) events from events scheduled to occur during a future duration. A execution profile of process 1 (in percentages) is indicated at the vertical axis at the left side of FIG. 11, and a measure of cumulative progress toward completion is indicated at the vertical axis at the right side of FIG. 11. Line 1120 indicates a measure of cumulative progress so as to account for incremental (e.g., weekly) progress toward completion of process 1.

With continued reference to FIG. 11, events occurring at weeks 4, 5, and 6 may be constrained to correspond to a completion rate of 4% per week. Additionally, events occurring at weeks 7 and 8 may be constrained to correspond to a completion rate of 6% per week. In particular embodiments, such constraints may be realized by linking, for example, a computer-implemented spreadsheet with a computer-implemented calendaring tool. In such a scenario, in view of constraints placed upon rates of completion at weeks 4-7, a computer-implemented model of a multi-event process may respread events beginning at week 10, to achieve a desired a cumulative completion of approximately 30% at week 12. In the embodiment of FIG. 11, in response to constraining completion rates at weeks 4-8, a computer-implemented model may respread events, such as to indicate that only a small amount of progress needs to be made at week 9 to achieve a 30% at week 10.

With continued reference to FIG. 11, in addition, a computer-implemented model for a multi-event process utilizing a computerized spreadsheet may employ a CPI having values other than 1.0. Accordingly, as indicated in Table 4 (below), a CPI of 1.2 may be applied to increase expected actual progress to a value greater than 1.0, to account for, for example, an effect of bringing on an additional shift, such as a swing shift or a night shift, so as to increase weekly progress of events of a particular process event. As shown in Table 4, similar to a CPI at weeks 4, 5, and 6 shown in Table 2, a contractor may schedule progress in accordance with a CPI of 1.0. However, to account for effects of adding a night shift or swing shift to complete events of a multi-event process, a execution profile of weekly events occurring at weeks 7 and 8, a CPI may be increased from 1.0 to, for example, 1.2. As indicated in FIG. 11, a execution profile of a respread event occurring at week 9 is indicated as being reduced to less than 2%.

TABLE 4

| CPI | | | | | |
|---|---|---|---|---|---|
| Adjustment | Week 4 | Week 5 | Week 6 | Week 7 | Week 8 |
| 1.0 | 4.0% | 4.0% | 4.0% | | |
| 1.2 | | | | 6.0% | 6.0% |

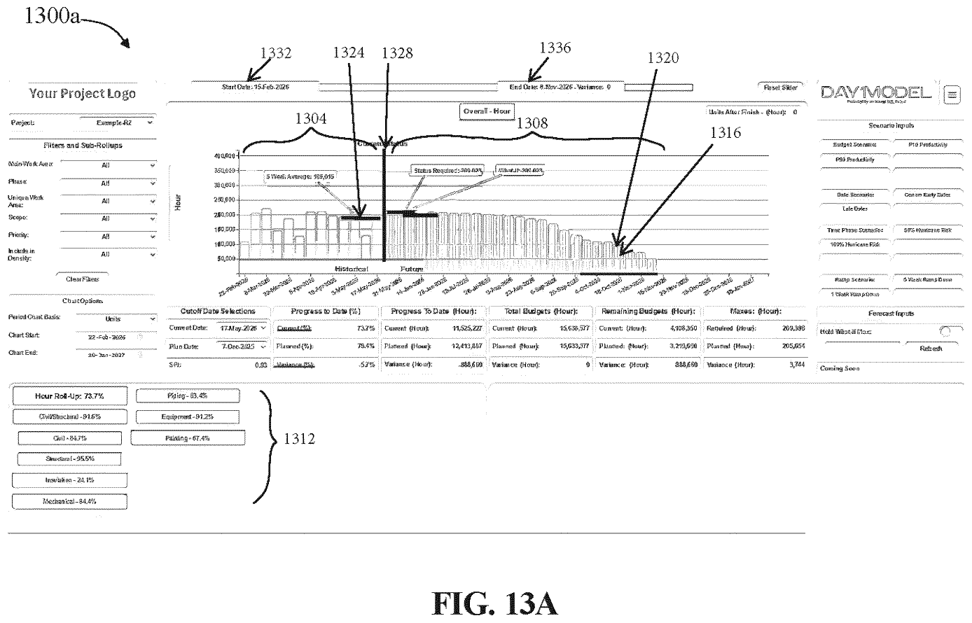

Referring now to FIGS. 12A-F, FIG. 12A depicts a visual representation of planned hourly events related to a process of driving from a point “A” to a point “C,” wherein points “A” and points “C” relate to locations on a map, according to an embodiment 1200. In one possible embodiment, point “A” may represent a first city (e.g., Austin, Texas), point “B” may represent a second city (e.g., Houston, Texas), and point “C” may represent a third city (e.g., New Orleans, Louisiana). The visual representations identified in FIG. 12A may be made possible via a user interacting with a computing platform or other computing entity such as described in relation to FIG. 6 and/or FIG. 7. In accordance with the embodiment of FIG. 12A, a driver may arrive at an initial plan, which may comprise a schedule having planned durations for progress to be made at hourly intervals so as to drive an automobile from point “A” to point “C.” The planned durations depicted in FIG. 12A indicates kilometers driven during particular intervals (e.g., hours) so as to arrive at point “C” at hour 14. Thus, in accordance with an initial plan, a driver is to cover approximately 96 kilometers in each of 14 hours. It should be noted that in particular embodiments, a scheduled plan that does not include a progress plan for kilometers covered per hour, may merely comprise a roadmap that does not account for actual progress made toward arrival at point “C.” Thus in particular embodiments, a time-phased structure of a computer-implemented progress model further expands a roadmap to form a progress assurance model. A progress assurance model may thus be utilized to generate required progress, as a function of hours driven, to proceed from point “A” to point “C.” It should be noted that typical scheduling tools do not include an approach to indicate, for example, a speed of travel along a map, which may be problematic, and may be addressed by at least particular embodiments of claimed subject matter. In the embodiment of FIG. 12A, a computer-implemented progress modeling tool has been linked to a map and schedule with kilometers covered per unit time (e.g., hours). It should also be noted that without accounting for the progress of process events, which may comprise, for example, kilometers driven per hour (or, for example, units of concrete poured per unit time), a driver or contractor may be permitted to merely modify (e.g., add or extend) the duration over which process events occur without a contracting officer, customer, or other type of overseer being apprised of a revised completion date of a particular process. Thus, it may be appreciated that without forming a link between a map and a schedule with process events (e.g., kilometers covered per hour, units of concrete poured per week, etc.) a new completion date may not become apparent to an overseer.

With continued reference to FIGS. 12A-F, in the embodiment of FIG. 12A, responsive to a driver leaving point “A” an event reporting period begins. Thus, a computer-implemented progress model operates to report progress after discrete process events (e.g., hourly progress events). In addition, the computer-implemented progress model accounts for the remaining process events (e.g., kilometers remaining to arrive at point “C”) that are to be completed and operates to respread process events, such as kilometers to be covered during future hours. Thus, in a broader sense, returning briefly to events relative to achieving weekly progress of events related to pouring concrete at a construction site, at the close of a given week, progress of the given week may be considered and the remaining units of concrete to be poured are revised so as to respread events over the remaining duration allotted to complete all concrete-pouring events of the process. Such respreading of process events may occur dynamically and rapidly so as to periodically (e.g., hourly, daily, weekly, etc.) provide an updated execution profile toward completion of a process of a multi-event process. Further, responsive to predecessor events occurring at progress rates less than those planned, an unplanned and undesirable bow wave of progress, which may occur without appropriate visibility by an overseer into remaining events of a process, may be avoided.

With continued reference to FIGS. 12A-F, FIG. 12B depicts a revised visual representation of planned hourly events responsive to a speculation based, at least in part, on an alternative driving scenario, according to embodiment 1201. In the embodiment of FIG. 2B, a driver may consider, for example, various scenarios, such as driving through city traffic populated with stoplights, which may impede driving progress toward point “C.” A driver may additionally consider a scenario in which rush-hour traffic and/or construction delays may also impede driving progress. Accordingly, as shown in FIG. 12B, such progress impediments may be visually represented so as to indicate that a driver may need to proceed at a speed of approximately 210 kilometers per hour, so as to arrive at point “C” at hour 14.

With continued reference to FIGS. 12A-F, FIG. 12C depicts a visual representation of respread hourly events related to a process of driving from point “A” to point “C” responsive to another alternative driving scenario, according to embodiment 1202. The embodiment of FIG. 12C may arise from consideration of speed and/or other limitations, such as recognition of the maximum safe driving speed limit. In such a scenario, an embodiment of a computer-implemented progress model may operate to increase a duration allotted for a process (e.g., driving from point “A” to point “C”). Thus, as shown in FIG. 12C, hours 15 and 16 are added, so as to extend a driving time beyond hour 14. In particular embodiments, computing platform 650 of FIG. SC, which may employ rules-based logic (656) coupled to time-phased process events (658), may operate to rapidly bring about the visual representation of FIG. 12C showing a consequence of recognition of a maximum safe driving speed limit. It may be appreciated that typical scheduling tools may be incapable of generating such visual representations. It may also be appreciated that computing platform 650 may facilitate interactive generation such visual representations in a matter of seconds-even for multi-event construction-related processes comprising hundreds or thousands of events.

With continued reference to FIGS. 12A-F, FIG. 12D depicts a visual representation of planned hourly events related to a process of driving from a point “A” to a point “C,” wherein points “A” and points “C” relate to locations on a map, according to an embodiment 1203. In FIG. 12D, planned progress impediments, such as city traffic delays, rush-hour delays, construction delays, and maximum safe speed limits, as indicated in FIG. 12A and FIG. 12B, are not considered. As shown in FIG. 12D, status line 1205 indicates an approximate halfway point of a process of driving from point “A” to a point “C.” Accordingly, in response to a driver covering approximately 650 kilometers toward point “C,” the driver may still be required to cover the remaining distance to point “C” in an allotted 7 hours. Accordingly, as indicated, to arrive at point “C,” the driver is to average approximately 212 kilometers per hour over the remaining 7 hour duration. In a construction-related embodiment, for example, a contractor may have poured only 200 cubic meters of concrete per week preceding multi-week duration, which may be in contrast to an originally planned pouring of 225 cubic meters of concrete per week over the duration. It may be appreciated that typical computer-implemented scheduling tools may permit a contractor to withhold scheduling and progress parameters from an overseer. In some instances, an unscrupulous contractor may claim that progress can be easily accelerated at future dates (e.g., by hiring additional personnel, securing additional equipment, etc.) or that an original schedule may have already considered delays in progress. Such claims may be difficult for an overseer to verify or to call into question in view of limitations of typical computer-implemented scheduling tools. In contrast, particular embodiments of claimed subject matter may operate to provide an overseer with a tool that facilitates such refuting of contractor claims or, on the other hand, verification of contractor claims.

With continued reference to FIGS. 12A-F, returning to FIG. 12D, a computer-implemented progress model may report that a driver's average speed over a predecessor 7-hour duration has been 80 kilometers per hour, rather than the originally planned 96 kilometers per hour. In addition, the progress model may provide a visual representation to indicate that the driver is to average approximately 212 kilometers per hour to arrive at point “C” at hour 14. Accordingly, a driver may generate a revised schedule to represent that, for example, to arrive at point “C” the driver will travel at a rate of speed of approximately 212 kilometers per hour over the future duration of 7 hours.

With continued reference to FIGS. 12A-F, FIG. 12E depicts a visual representation showing speculated hourly events related to driving from point “A” to point “C” in view of predecessor events being below originally planned progress, according to an embodiment 1204. In the embodiment of FIG. 12E, predecessor events indicate that the driver has progressed toward point “C” for a preceding 7-hour duration at a rate of speed of 80 kilometers per hour. As indicated, responsive to the driver progressing at a rate of speed of 80 kilometers per hour, a computer-implemented progress model indicates that the driver is now scheduled to arrive at point “C” at hour 17, rather than at hour 14, as originally planned. It may be appreciated that FIG. 12E indicates a normalization of respread future events based on actual predecessor events, such as the driver's speed over the previous 7-hour period.

With continued reference to FIGS. 12A-F, FIG. 12F depicts a visual representation showing actual predecessor and speculated future events related to driving from point “A” to point “C” in view of predecessor events being below originally planned progress, according to an embodiment 1206. As shown in FIG. 12F, after averaging 80 kilometers per hour during hours 1-7, the driver has covered approximately 204 kilometers during hour 8 and approximately 65 kilometers at hour 9. Status line 1210 indicates the driver's progress at the end of hour 9, Accordingly, a computer-implemented progress model may indicate that the driver is to cover the remaining distance during hours 10-14. As indicated, to cover such a distance, the driver may be scheduled to increase the rate of speed to approximately 248 kilometers per hour, which may be infeasible. As previously indicated, such an unreasonable increase in driver speed may represent a problematic bow wave event, in which a driver may claim that such a driving speed during hours 10-14 can be achieved, and that an overseer need not be concerned that progress toward point “C” at hour 14 is still fully attainable. It may be appreciated that particular embodiments of claimed subject matter may operate to provide an overseer with detailed insight which may operate to refute or call into question such claims. In such instances, a contracting officer, customer, or other type of overseer may, instead, present a visual representation indicating more reasonable progress, such as that shown in FIG. 12E, which indicates that the driver is more likely to arrive at point “C” at hour 17, or an even later time, which may be more realistic than an assumption that a driver can maintain a speed of 232 kilometers per hour over hours 10-14.

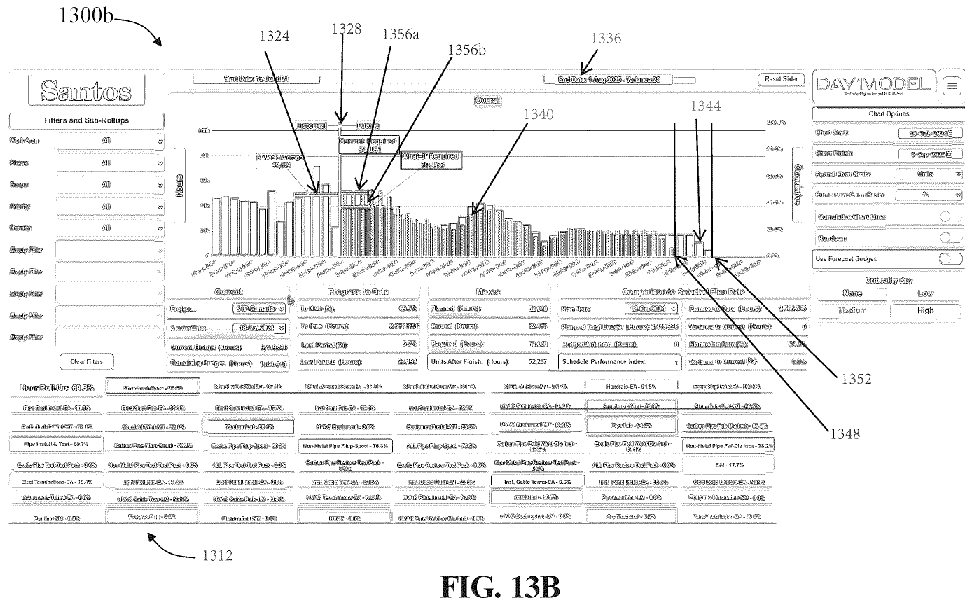

Referring now to FIG. 13A, an exemplary dynamic user interface 1300a is illustrated. In some embodiments, dynamic user interface 1300a may be designed to provide a personalized and responsive experience by updating its content, layout, or functionality based on user input 142, first execution profile, second execution profile, temporal element, event attribute, or the like. In some embodiments, dynamic user interface 1300a may include first visual representation, digitized representation of predecessor events 1304, successor events 1308, event subset 1312, event attributes, temporal element, first visual data points 1316, first execution profile, user input, second execution profile, second visual representation, second visual data points 1320, anomaly indicating datum, probability factor, earned datum, representation label, feasibility datum, profile decrease element, first future duration, second future duration, current status date, and the like.

With continued reference to FIG. 13, a user may input a user input through dynamic user interface 1300a. In some embodiments, user input may be associated with a manipulation of graphical elements of dynamic user interface 1300a. In some embodiments, at least a part of graphical elements may be associated with one or more first visual data points 1316. As a non-limiting example, user input may be associated with average line 1324, status line 1328, temporal element, estimated loss or gain, first visual representation, first visual data points 1316, start date 1332, end date 1336, first future duration, second future duration, event subset 1312, and/or the like. For example, and without limitation, user input may include a manipulation of each bar of a bar chart and processor may update or generate second visual representation as a function of the manipulation of the bar. For example, and without limitation, user may manipulate a graphical element illustrating end date 1336 to extend or shorten a future duration of successor events 1308. For example, and without limitation, For example, and without limitation, user may manipulate a graphical element illustrating event subset 1312 to get a visual representation or metadata of the event subset 1312 displayed on dynamic user interface 1300a.

Referring now to FIG. 13B, an exemplary dynamic user interface 1300b is illustrated. In some embodiments, dynamic user interface 1300b may include first visual representation 1340 including first visual data points, digitized representation of predecessor events, successor events, event attributes, first execution profile, user input, second execution profile, second visual representation 1344 including second visual data points, anomaly indicating datum, probability factor, earned datum, representation label, feasibility datum, profile decrease element, first future duration 1348, second future duration 1352, and the like. In some embodiments, dynamic user interface 1300b may include a plurality of graphical elements representing event subset 1312, current status date, temporal elements, benchmark, and the like. For example, and without limitation, dynamic user interface 1300b may include a graphical element representing end date 1336. For example, and without limitation, dynamic user interface 1300b may include an average line 1324 of predecessor events, average line of first execution profile, average line of second execution profile, and the like. For example, and without limitation, dynamic user interface 1300b may include a graphical element representing a maximum outputs a project. For example, and without limitation, dynamic user interface 1300b may include benchmark lines 1356a-b, where benchmark line 1356a indicates a status required (e.g., required amount or value of productivity, hours, production, or the like) and benchmark line 1356b indicates a predicted average or maximum value of productivity, hours, production, or the like based on second execution profile. In some embodiments, dynamic user interface 1300b may display first visual representation 1340 and second visual representation 1344 in a separate window or section. In some embodiments, dynamic user interface 1300b may overlay second visual representation 1344 and first visual representation 1340 as illustrated in FIG. 13B.

Referring now to FIGS. 14A-B, exemplary first visual representation 1400a and exemplary second visual representation 1400b are illustrated. In some embodiments, first visual representation 1400a may include a plurality of first visual data points 1404. As a non-limiting example, first visual representation 1400a may include a bar graph containing bars (first visual data points 1404). In some embodiments, first visual representation 1400a may include an average line 1408a. In some embodiments, first visual representation 1400a may include a status line 1412a. In some embodiments, user may modify current status date by typing different date into user input field or selecting different date within a list of dates. In some embodiments, user may modify current status date by manipulating status line 1412a. In a non-limiting example, user may drag status line 1412a towards successor events (e.g., a direction of an arrow illustrated in FIG. 14A) and processor may generate a second visual representation 1400b according to the change of status line 1412a of first visual representation 1400a to status line 1412b. In some embodiments, as current status date is modified based on the change of status line 1412a, average line 1408b of second visual representation 1400b, predecessor events and second execution profile of successor events may be modified as well. In a non-limiting example, as a user extends or modifies a current status date closer to an end of successor events, processor may compute a second execution profile based on a benchmark value or average value of predecessor events. For example, and without limitation, by comparing FIGS. 14A and 14B, it can be shown that visual data points of predecessor events on the left side of status line 1412a and status line 1412b in FIGS. 14A and 14B are different. For example, and without limitation, by comparing FIGS. 14A and 14B, it can be shown that status line 1412b visual data points of successor events on the right side of status line 1412a and status line 1412b are different.

Referring now to FIG. 15, exemplary digitized representations 1500a-b of predecessor events 1504a-b and corresponding exemplary visual representations 1508a-b are illustrated. In some embodiments, visual representations 1508a-b may include multi-event process. In some embodiments, digitized representations 1500a-b of predecessor events 1504a-b may include one or more event attributes. In some embodiments, event attributes may include temporal elements. In some embodiments, temporal elements of digitized representations 1500a of predecessor events 1504a may include a start date 1512a, end date 1516a, duration 1520a of each of predecessor events 1504a, and the like. In some embodiments, temporal elements of digitized representations 1500b of predecessor events 1504b may include a start date 1512b, end date 1516b, duration 1520b of each of predecessor events 1504b, and the like. In some embodiments, first event of the predecessor events 1504a may include an earliest start date 1524a and a last event of the predecessor events 1504a may include a latest end date 1528a. In some embodiments, a user may modify the earliest start date 1524a and latest end date 1528a (e.g., user input). Digitized representation 1500b shows the modified temporal elements: for instance, and without limitation, first event of the predecessor events 1504b may include a modified earliest start date 1524b and a last event of the predecessor events 1504b may include a modified latest end date 1528b. Continuing the non-limiting instance, every start dates 1512b, end dates 1516b and durations 1520b may be modified based on the modified earliest start date 1524b and modified latest end date 1528b. For example, and without limitation, processor may compute modified start dates 1512b, end dates 1516b and durations 1520b based on a gap 1532a between predecessor events 1504a (gap 1532a is illustrated in visual representation 1508a). This ensures that while the modified start dates 1512b, end dates 1516b, and durations 1520b may be extended or shortened, the gap 1532a between predecessor events 1504a remains unchanged. As a result, gap 1532a between predecessor events 1504a and gap 1532b between predecessor events 1504b (gap 1532b is illustrated in visual representation 1508b) may be maintained as identical. In some embodiments, gap 1532a-b may include days, times, numbers, amounts, and the like. For example, and without limitation, gap 1532a-b may include 21 days. Visual representations 1508a-b may be generated based on digitized representations 1500a-b of predecessor events 1504a-b.

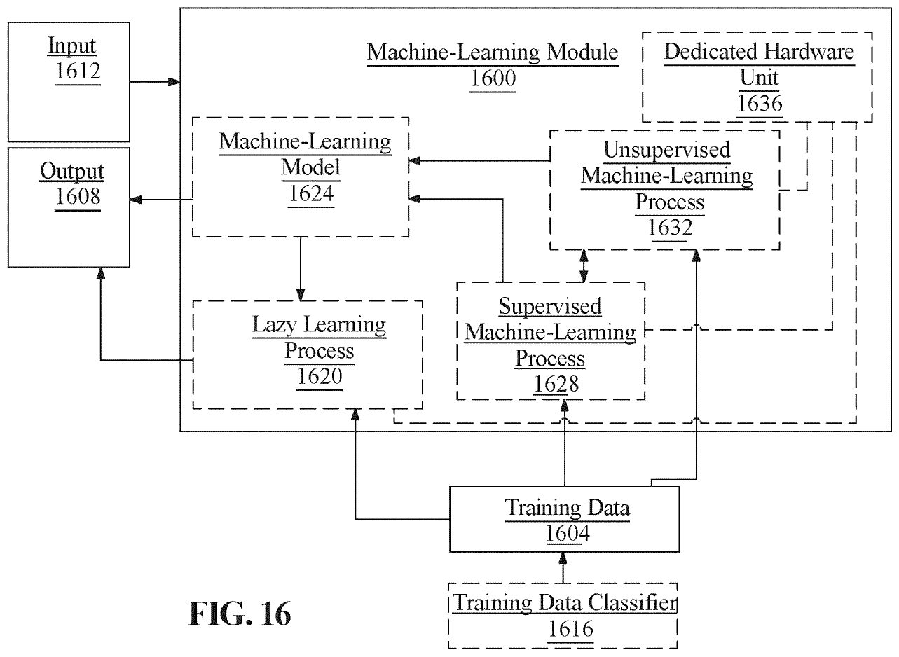

Referring now to FIG. 16, an exemplary embodiment of a machine-learning module 1600 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1604 to generate an algorithm instantiated in hardware or software logic, data structures, and/or functions that will be performed by a computing device/module to produce outputs 1608 given data provided as inputs 1612; this is in contrast to a non-machine learning software program where the commands to be executed are determined in advance by a user and written in a programming language.

Still referring to FIG. 16, “training data,” as used herein, is data containing correlations that a machine-learning process may use to model relationships between two or more categories of data elements. For instance, and without limitation, training data 1604 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1604 according to various correlations; correlations may indicate causative and/or predictive links between categories of data elements, which may be modeled as relationships such as mathematical relationships by machine-learning processes as described in further detail below. Training data 1604 may be formatted and/or organized by categories of data elements, for instance by associating data elements with one or more descriptors corresponding to categories of data elements. As a non-limiting example, training data 1604 may include data entered in standardized forms by persons or processes, such that entry of a given data element in a given field in a form may be mapped to one or more descriptors of categories. Elements in training data 1604 may be linked to descriptors of categories by tags, tokens, or other data elements; for instance, and without limitation, training data 1604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 16, training data 1604 may include one or more elements that are not categorized; that is, training data 1604 may not be formatted or contain descriptors for some elements of data. Machine-learning algorithms and/or other processes may sort training data 1604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1604 to be made applicable for two or more distinct machine-learning algorithms as described in further detail below. Training data 1604 used by machine-learning module 1600 may correlate any input data as described in this disclosure to any output data as described in this disclosure. As a non-limiting illustrative example training data may include a plurality of historical project data as input correlated to a plurality of schedules/adjustments as output. As a non-limiting illustrative example, input data may include digitized representation of predecessor events, event attributes, temporal elements, event subsets, current status date, event execution, successor events, remaining execution, execution profiles, future durations, user inputs, profile decrease elements, anomaly indicating datums, probability factors, representation labels, and the like. As a non-limiting illustrative example, output data may include execution profiles, future durations, profile decrease elements, anomaly indicating datums, probability factors, representation labels, earned data, feasibility data, visual representations, and the like.

Further referring to FIG. 16, training data may be filtered, sorted, and/or selected using one or more supervised and/or unsupervised machine-learning processes and/or models as described in further detail below; such models may include without limitation a training data classifier 1616. Training data classifier 1616 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1600 may generate a classifier using a classification algorithm, defined as a processes whereby a computing device and/or any module and/or component operating thereon derives a classifier from training data 1604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1616 may classify elements of training data to a user cohort such as a type of industry, location, size, and the like. As a non-limiting example, training data classifier 1616 may classify elements of training data to a project cohort such as a type of project, size, and the like.

Still referring to FIG. 16, computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 16, computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 16, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 17] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 16, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 16, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 16, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 16, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 16, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 200 pixels, however a desired number of pixels may be 228. Processor may interpolate the low pixel count image to convert the 200 pixels into 228 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 16, computing device, processor, and/or module may down-sample elements of a training example to a desired lower number of data elements. As a non-limiting example, a high pixel count image may have 356 pixels, however a desired number of pixels may be 228. Processor may down-sample the high pixel count image to convert the 356 pixels into 228 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 16, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 16, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Still referring to FIG. 16, machine-learning module 1600 may be configured to perform a lazy-learning process 1620 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1604. Heuristic may include selecting some number of highest-ranking associations and/or training data 1604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 16, machine-learning processes as described in this disclosure may be used to generate machine-learning models 1624. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1624 may be generated by creating an artificial neural network, such as a convolutional neural network comprising an input layer of nodes, one or more intermediate layers, and an output layer of nodes. Connections between nodes may be created via the process of “training” the network, in which elements from a training data 1604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 16, machine-learning algorithms may include at least a supervised machine-learning process 1628. At least a supervised machine-learning process 1628, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include a plurality of historical project data as described above as inputs, a plurality of event execution profiles as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. For another instance, a supervised learning algorithm may include digitized representation of predecessor events, event attributes, temporal elements, event subsets, current status date, event execution, successor events, remaining execution, execution profiles, future durations, user inputs, profile decrease elements, anomaly indicating datums, probability factors, representation labels, and the like as described above as inputs, execution profiles, future durations, profile decrease elements, anomaly indicating datums, probability factors, representation labels, earned data, feasibility data, visual representations, and the like as outputs, and a scoring function representing a desired form of relationship to be detected between inputs and outputs. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1604. Persons skilled in the art, upon reviewing the entirety of this disclosure, will be aware of various possible variations of at least a supervised machine-learning process 1628 that may be used to determine relation between inputs and outputs. Supervised machine-learning processes may include classification algorithms as defined above.

With further reference to FIG. 16, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 16, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 16, machine learning processes may include at least an unsupervised machine-learning processes 1632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1632 may not require a response variable; unsupervised processes 1132 may be used to find interesting patterns and/or inferences between variables, to determine a degree of correlation between two or more variables, or the like.

Still referring to FIG. 16, machine-learning module 1600 may be designed and configured to create a machine-learning model 1624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 16, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 16, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 16, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 16, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 16, one or more processes or algorithms described above may be performed by at least a dedicated hardware unit 1636. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1636 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1636 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1636 to perform one or more operations described herein, such as evaluation of model and/or algorithm outputs, one-time or iterative updates to parameters, coefficients, weights, and/or biases, and/or any other operations such as vector and/or matrix operations as described in this disclosure.

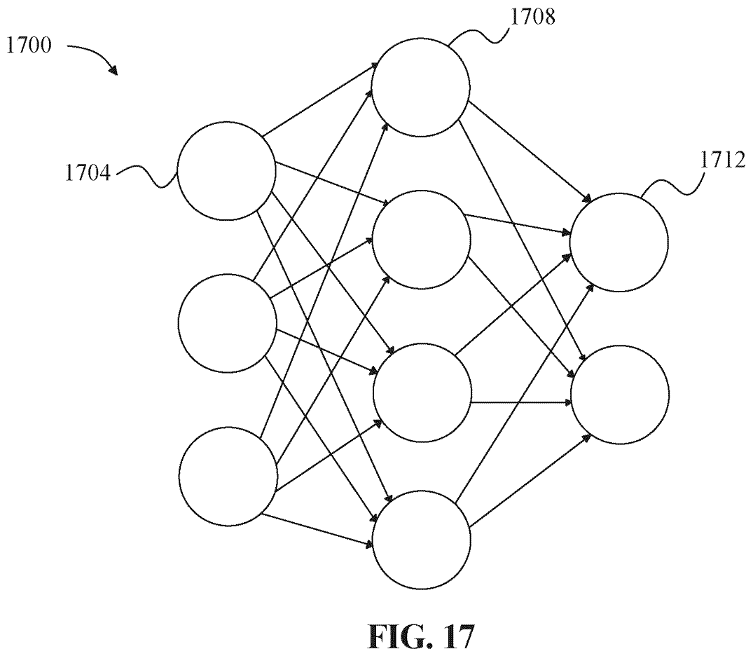

Referring now to FIG. 17, an exemplary embodiment of neural network 1700 is illustrated. A neural network 1700 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1704, one or more intermediate layers 1708, and an output layer of nodes 1712. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

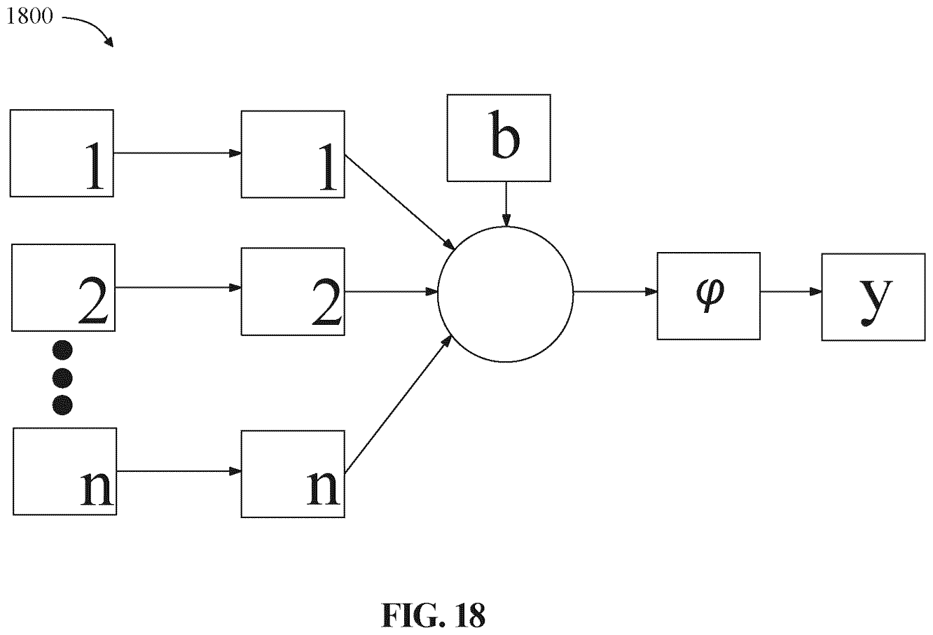

Referring now to FIG. 18, an exemplary embodiment of a node 1800 of a neural network is illustrated. A node may include, without limitation a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max(0, x), a “leaky” and/or “parametric” rectified linear unit function such as f(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

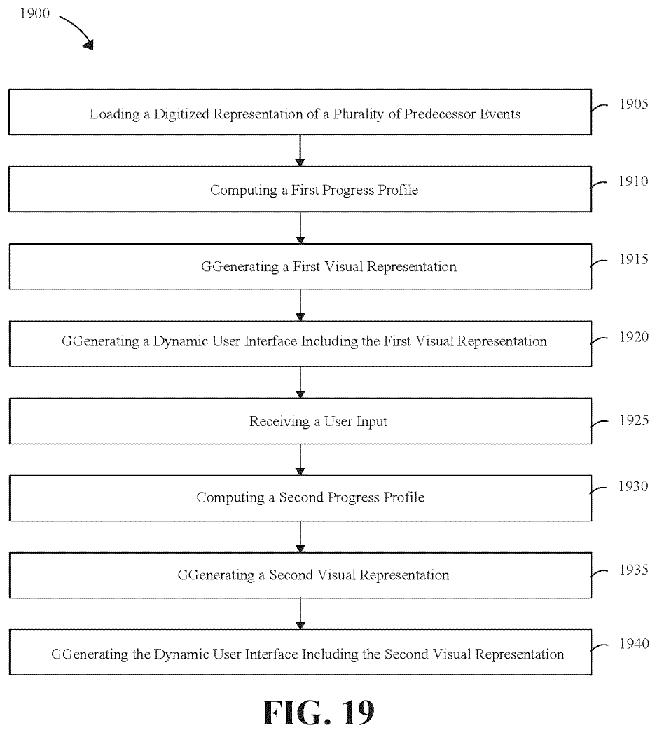

Referring now to FIG. 19, a flow diagram of an exemplary computer-implemented method 1900 of dynamic modeling of events including a graphical user interface is illustrated. Method 1900 contains a step 1905 of loading, using at least a processor into one or more computer memory devices, a digitized representation of a plurality of predecessor events, wherein the plurality of predecessor events includes one or more event attributes. This may be implemented as reference to FIGS. 1-18.

With continued reference to FIG. 19, method 1900 contains a step 1910 of computing, using the at least a processor, a first execution profile of each of a plurality of successor events as a function of, at least in part, one or more event attributes, wherein computing the first execution profile includes identifying at least a profile parameter of the plurality of predecessor events, wherein the at least a profile parameter includes one or more of a ramp-up phase and a ramp-down phase and generating the first execution profile as a function of the at least a profile parameter. This may be implemented as reference to FIGS. 1-18.

With continued reference to FIG. 19, method 1900 contains a step 1915 of generating, using at least a processor, a first visual representation including one or more first visual data points, wherein each of the one or more first visual data points represents each of a plurality of predecessor events and a first execution profile of each of a plurality of successor events. In some embodiments, generating the first visual representation may include generating the first visual representation as a function of at least a temporal element of the one or more event attributes. In some embodiments, the user input may include a modification of an end date of the at least a temporal element. In some embodiments, the dynamic user interface may include an event handler associated with a status line of graphical elements of the dynamic user interface, wherein the event handler may be configured to detect a change in a position of the status line and trigger a change in at least a part of the second visual representation as a function of the detection. In some embodiments, the dynamic user interface may include an event handler associated with a profile decrease element, wherein the event handler is configured to detect a selection of the profile decrease element and trigger a change in at least a part of the second visual representation as a function of the selected profile decrease element. In some embodiments, generating the first visual representation may include generating the first execution profile as a function of at least an event subset of the plurality of predecessor events and generating the first visual representation for the at least an event subset as a function of the first execution profile. These may be implemented as reference to FIGS. 1-18.

With continued reference to FIG. 19, method 1900 contains a step 1920 of generating, using at least a processor, a dynamic user interface including a first visual representation. This may be implemented as reference to FIGS. 1-18.

With continued reference to FIG. 19, method 1900 contains a step 1925 of receiving, using at least a processor, a user input through a dynamic user interface. This may be implemented as reference to FIGS. 1-18.

With continued reference to FIG. 19, method 1900 contains a step 1930 of computing, using at least a processor, a second execution profile as a function of a user input, wherein computing the second execution profile includes modifying at least a part of one or more event attributes of a plurality of predecessor events as a function of the user input. In some embodiments, computing the second execution profile may include computing the second execution profile as a function of a manipulation of a status line of graphical elements of the dynamic user interface. These may be implemented as reference to FIGS. 1-18.

With continued reference to FIG. 19, method 1900 contains a step 1935 of generating, using at least a processor, a second visual representation including one or more second visual data points as a function of a second execution profile. In some embodiments, generating the second visual representation may include labeling the second visual representation with a representation label, storing the second visual representation with the representation label to a database and retrieving the second visual representation from the database as a function of a query received as a part of the user input. These may be implemented as reference to FIGS. 1-18.

With continued reference to FIG. 19, method 1900 contains a step 1940 of generating, using at least a processor, a dynamic user interface including a second visual representation. In some embodiments, method 1900 may further include computing the first execution profile by spreading at least a portion of a remaining execution across a first future duration associated with the plurality of successor events as a function of a difference between an event execution of the plurality of predecessor events and a target attribute of the one or more event attributes and a proportion of each of the plurality of successor events relative to a sum of the plurality of successor events and computing the second execution profile by respreading the at least a portion of the remaining execution across a second future duration associated with the plurality of successor events as a function of the difference of between the event execution of the plurality of predecessor events and the target attribute of the one or more event attributes and a modified proportion of each of the plurality of successor events relative to a modified sum of the plurality of successor events.

In some embodiments, method 1900 may further include determining a anomaly indicating datum as a function of a digitized representation of the plurality of predecessor events, generating a feasibility datum as a function of the anomaly indicating datum and generating the dynamic user interface including the feasibility datum and the anomaly indicating datum. These may be implemented as reference to FIGS. 1-18.

In the context of hardware entities of FIG. 6 of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of actual values of predecessor events, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more actual values of predecessor events.

The terms “correspond,” “reference,” “associate,” and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory (e.g., memory 654 of FIG. 6), such as for processing by a processor and/or similar device, for example. Thus, in a particular context, “associating,” “referencing,” and/or “corresponding” may, for example, refer to an executable process of accessing contents of memory 654 of two or more memory locations, for example, to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network, such as devices of network 630 of FIG. 6, may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the term network device, such as with respect to devices of network 630 of FIG. 6, refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms “client,” “client device,” “client computing device,” “client computing platform,” and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a device of network 630 may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

The terms “computer-implemented spreadsheet” and “computer-implemented calendar” or variations of these terms are utilized in this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted that an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

As suggested previously, communications between a computing device and/or a network device (e.g., a device of network 630) and a wireless network may be in accordance with known and/or to be developed network protocols including, for example, global system for mobile communications (GSM), enhanced data rate for GSM evolution (EDGE), 902.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing platform and/or device of network 630 may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing platform and/or device of network 630 may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing platform and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, and/or the like. A computing platform and/or network device may also include executable computer instructions to perform a variety of possible tasks, such as browsing, searching, playing various forms of digital content, including locally stored and/or streamed video, and/or games. The foregoing is provided merely to illustrate that claimed subject matter is intended to include a wide range of possible features and/or capabilities.

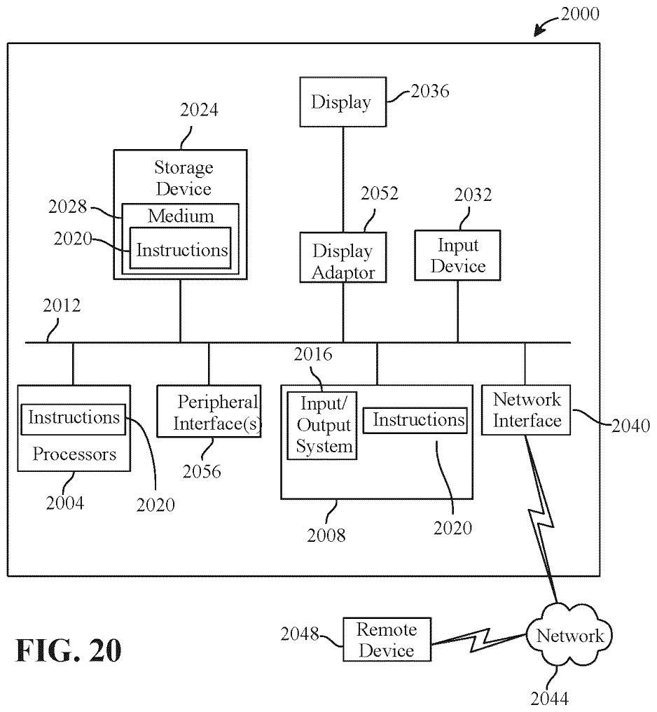

FIG. 20 shows a diagrammatic representation of one embodiment of a computing device in the exemplary form of a computer system 2000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 2000 includes a processor 2004 and a memory 2008 that communicate with each other, and with other components, via a bus 2012. Bus 2012 may include any of several types of bus structures including, but not limited to, a memory bus, a memory controller, a peripheral bus, a local bus, and any combinations thereof, using any of a variety of bus architectures.

Processor 2004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 2004 may be organized according to Von Neumann and/or Harvard architecture as a non-limiting example. Processor 2004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 2008 may include various components (e.g., machine-readable media) including, but not limited to, a random-access memory component, a read only component, and any combinations thereof. In one example, a basic input/output system 2016 (BIOS), including basic routines that help to transfer information between elements within computer system 2000, such as during start-up, may be stored in memory 2008. Memory 2008 may also include (e.g., stored on one or more machine-readable media) instructions (e.g., software) 2020 embodying any one or more of the aspects and/or methodologies of the present disclosure. In another example, memory 2008 may further include any number of program modules including, but not limited to, an operating system, one or more application programs, other program modules, program data, and any combinations thereof.

Computer system 2000 may also include a storage device 2024. Examples of a storage device (e.g., storage device 2024) include, but are not limited to, a hard disk drive, a magnetic disk drive, an optical disc drive in combination with an optical medium, a solid-state memory device, and any combinations thereof. Storage device 2024 may be connected to bus 2012 by an appropriate interface (not shown). Example interfaces include, but are not limited to, SCSI, advanced technology attachment (ATA), serial ATA, universal serial bus (USB), IEEE 1694 (FIREWIRE), and any combinations thereof. In one example, storage device 2024 (or one or more components thereof) may be removably interfaced with computer system 2000 (e.g., via an external port connector (not shown)). Particularly, storage device 2024 and an associated machine-readable medium 2028 may provide nonvolatile and/or volatile storage of machine-readable instructions, data structures, program modules, and/or other data for computer system 2000. In one example, software 2020 may reside, completely or partially, within machine-readable medium 2028. In another example, software 2020 may reside, completely or partially, within processor 2004.

Computer system 2000 may also include an input device 2032. In one example, a user of computer system 2000 may enter commands and/or other information into computer system 2000 via input device 2032. Examples of an input device 2032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 2032 may be interfaced to bus 2012 via any of a variety of interfaces (not shown) including, but not limited to, a serial interface, a parallel interface, a game port, a USB interface, a FIREWIRE interface, a direct interface to bus 2012, and any combinations thereof. Input device 2032 may include a touch screen interface that may be a part of or separate from display 2036, discussed further below. Input device 2032 may be utilized as a user selection device for selecting one or more graphical representations in a graphical interface as described above.

A user may also input commands and/or other information to computer system 2000 via storage device 2024 (e.g., a removable disk drive, a flash drive, etc.) and/or network interface device 2040. A network interface device, such as network interface device 2040, may be utilized for connecting computer system 2000 to one or more of a variety of networks, such as network 2044, and one or more remote devices 2048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 2044, may employ a wired and/or a wireless mode of communication. In general, any network topology may be used. Information (e.g., data, software 2020, etc.) may be communicated to and/or from computer system 2000 via network interface device 2040.

Computer system 2000 may further include a video display adapter 2052 for communicating a displayable image to a display device, such as display 2036. Examples of a display device include, but are not limited to, a liquid crystal display (LCD), a cathode ray tube (CRT), a plasma display, a light emitting diode (LED) display, and any combinations thereof. Display adapter 2052 and display 2036 may be utilized in combination with processor 2004 to provide graphical representations of aspects of the present disclosure. In addition to a display device, computer system 2000 may include one or more other peripheral output devices including, but not limited to, an audio speaker, a printer, and any combinations thereof. Such peripheral output devices may be connected to bus 2012 via a peripheral interface 2056. Examples of a peripheral interface include, but are not limited to, a serial port, a USB connection, a FIREWIRE connection, a parallel connection, and any combinations thereof.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining,” “establishing,” “obtaining,” “identifying,” “selecting,” “generating,” and/or the like may refer to actions and/or processes of a specific apparatus, such as a special purpose computing platform and/or a similar special purpose computing platform and/or network device (e.g., a device of network 630). In the context of this specification, therefore, a special purpose computing platform and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computing platform and/or similar special purpose computing and/or network device. In the context of this particular patent application, as mentioned, the term “specific apparatus” therefore includes a general purpose computing platform and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A computer-implemented method of dynamic modeling of events, the method comprising:
loading, using at least a processor into one or more computer memory devices, a digitized representation of a plurality of predecessor events, wherein the plurality of predecessor events comprises one or more event attributes;
computing, using the at least a processor, a first execution profile of each of a plurality of successor events as a function of, at least in part, the one or more event attributes, wherein computing the first execution profile comprises:
identifying at least a profile parameter of the plurality of predecessor events, wherein the at least a profile parameter comprises one or more of a ramp-up phase and a ramp-down phase; and
generating the first execution profile as a function of the at least a profile parameter;
generating, using the at least a processor, a first visual representation comprising one or more first visual data points, wherein each of the one or more first visual data points represents each of the plurality of predecessor events and the first execution profile of each of the plurality of successor events;
generating, using the at least a processor, a dynamic user interface comprising the first visual representation;
receiving, using the at least a processor, a user input through the dynamic user interface;
computing, using the at least a processor, a second execution profile as a function of the user input, wherein computing the second execution profile comprises modifying at least a part of the one or more event attributes of the plurality of predecessor events as a function of the user input;
generating, using the at least a processor, a second visual representation comprising one or more second visual data points as a function of the second execution profile; and
generating, using the at least a processor, the dynamic user interface comprising the second visual representation.

2. The method of claim 1, further comprising:
computing the first execution profile by spreading at least a portion of a remaining execution across a first future duration associated with the plurality of successor events as a function of:
a difference between an event execution of the plurality of predecessor events and a target attribute of the one or more event attributes; and
a proportion of each of the plurality of successor events relative to a sum of the plurality of successor events; and
computing the second execution profile by respreading the at least a portion of the remaining execution across a second future duration associated with the plurality of successor events as a function of:
the difference between the event execution of the plurality of predecessor events and the target attribute of the one or more event attributes; and
a modified proportion of each of the plurality of successor events relative to a modified sum of the plurality of successor events.

3. The method of claim 1, wherein generating the first visual representation comprises generating the first visual representation as a function of at least a temporal element of the one or more event attributes.

4. The method of claim 3, wherein the user input comprises a modification of an end date of the at least a temporal element.

5. The method of claim 3, wherein computing the second execution profile comprises computing the second execution profile as a function of a modification of a status line of graphical elements of the dynamic user interface, wherein the status line is associated with a current status date of the at least a temporal element.

6. The method of claim 1, wherein generating the first visual representation comprises:
generating the first execution profile as a function of at least an event subset of the plurality of predecessor events; and
generating the first visual representation for the at least an event subset as a function of the first execution profile.

7. The method of claim 1, wherein the dynamic user interface comprises an event handler associated with a status line of graphical elements of the dynamic user interface, wherein the event handler is configured to:
detect a change in a position of the status line; and
trigger a change in at least a part of the second visual representation as a function of the detection.

8. The method of claim 1, wherein the dynamic user interface comprises an event handler associated with a profile decrease element, wherein the event handler is configured to:
detect a selection of the profile decrease element; and
trigger a change in at least a part of the second visual representation as a function of the selected profile decrease element.

9. The method of claim 1, wherein generating the second visual representation comprises:
labeling the second visual representation with a representation label;
storing the second visual representation with the representation label to a database; and
retrieving the second visual representation from the database as a function of a query received as a part of the user input.

10. The method of claim 1, further comprising:
determining an anomaly indicating datum as a function of the digitized representation of the plurality of predecessor events;
generating a feasibility datum as a function of the anomaly indicating datum; and
generating the dynamic user interface comprising the feasibility datum and the anomaly indicating datum.

11. An apparatus for dynamic modeling of events, wherein the apparatus comprises:
at least one processor; and
one or more computer memory devices communicatively connected to the at least one processor, wherein the one or more computer memory devices contains instructions configuring the at least one processor to:
load, into one or more computer memory devices, a digitized representation of a plurality of predecessor events, wherein the plurality of predecessor events comprises one or more event attributes;
compute a first execution profile of each of a plurality of successor events as a function of, at least in part, the one or more event attributes, wherein computing the first execution profile comprises:
identifying at least a profile parameter of the plurality of predecessor events, wherein the at least a profile parameter comprises one or more of a ramp-up phase and a ramp-down phase; and
generating the first execution profile as a function of the at least a profile parameter;
generate a first visual representation comprising one or more first visual data points, wherein each of the one or more first visual data points represents each of the plurality of predecessor events and the first execution profile of each of the plurality of successor events;
generate a dynamic user interface comprising the first visual representation;
receive a user input through the dynamic user interface;
compute a second execution profile as a function of the user input, wherein computing the second execution profile comprises modifying at least a part of the one or more event attributes of the plurality of predecessor events as a function of the user input;
generate a second visual representation comprising one or more second visual data points as a function of the second execution profile; and
generate the dynamic user interface comprising the second visual representation.

12. The apparatus of claim 11, wherein the computer memory device contains instructions configuring the at least a processor to:
compute the first execution profile by spreading at least a portion of a remaining execution across a first future duration associated with the plurality of successor events as a function of:
a difference between an event execution of the plurality of predecessor events and a target attribute of the one or more event attributes; and
a proportion of each of the plurality of successor events relative to a sum of the plurality of successor events; and
compute the second execution profile by respreading the at least a portion of the remaining execution across a second future duration associated with the plurality of successor events as a function of:
the difference between the event execution of the plurality of predecessor events and the target attribute of the one or more event attributes; and
a modified proportion of each of the plurality of successor events relative to a modified sum of the plurality of successor events.

13. The apparatus of claim 11, wherein generating the first visual representation comprises generating the first visual representation as a function of at least a temporal element of the one or more event attributes.

14. The apparatus of claim 13, wherein the user input comprises a modification of an end date of the at least a temporal element.

15. The apparatus of claim 13, wherein computing the second execution profile comprises computing the second execution profile as a function of a modification of a status line of graphical elements of the dynamic user interface, wherein the status line is associated with a current status date of the at least a temporal element.

16. The apparatus of claim 11, wherein generating the first visual representation comprises:
generating the first execution profile as a function of at least an event subset of the plurality of predecessor events; and
generating the first visual representation for the at least an event subset as a function of the first execution profile.

17. The apparatus of claim 11, wherein the dynamic user interface comprises an event handler associated with a status line of graphical elements of the dynamic user interface, wherein the event handler is configured to:
detect a change in a position of the status line; and
trigger a change in at least a part of the second visual representation as a function of the detection.

18. The apparatus of claim 11, wherein the dynamic user interface comprises an event handler associated with a profile decrease element, wherein the event handler is configured to:
detect a selection of the profile decrease element; and
trigger a change in at least a part of the second visual representation as a function of the selected profile decrease element.

19. The apparatus of claim 11, wherein generating the second visual representation comprises:
labeling the second visual representation with a representation label;
storing the second visual representation with the representation label to a database; and
retrieving the second visual representation from the database as a function of a query received as a part of the user input.

20. The apparatus of claim 11, wherein the computer memory device contains instructions configuring the at least a processor to:
determine an anomaly indicating datum as a function of the digitized representation of the plurality of predecessor events;
generate a feasibility datum as a function of the anomaly indicating datum; and
generate the dynamic user interface comprising the feasibility datum and the anomaly indicating datum.
